(19) United States
(12) Patent Application Publication
(10) Pub. No.: US 2015/0278182 A1
(43) Pub. Date: Oct. 1, 2015

(54) SYSTEM AND METHOD FOR ANNOTATING WEBPAGES

(71) Applicant: Project T, LLC, Dallas, TX (US)

(72) Inventors: George Francis Nicholas, Dallas, TX (US); Stephen Joshua Parish, Richardson, TX (US); Judd Daniel Cobler, Plano, TX (US); Joseph Nicholas, Sunny Isles Beach, FL (US)

(21) Appl. No.: 14/711,455

(22) Filed: May 13, 2015

Related U.S. Application Data
(63) Continuation-in-part of application No. 14/242,517, filed on Apr. 1, 2014.

(51) Int. Cl. G06F 17/24; G06Q 10/10; G06Q 30/02; H04L 29/08; G06F 3/0484

(52) U.S. Cl. CPC G06F 17/241; H04L 67/02; G06F 3/04842; G06Q 30/0206; G06Q 10/1053

(57) ABSTRACT

A system and method for annotating webpages including a method for annotating webpages by a user of a research service, the method including: logging in to a research service account under an owner name associated with the user, the research service account including data storage for the user; displaying a website having a URL in a web browser on a personal device; capturing content from the website; generating a citation for the captured content; associating the content with linked information to form a research block, the linked information including the citation, the owner name, the URL, and a creation date; and storing the research block in the data storage remote from the personal device.

### CROSS-REFERENCE TO RELATED APPLICATIONS

This application is a continuation-in-part of U.S. patent application Ser. No. 14/242,517, entitled System and Method for Annotating Webpages, filed Apr. 1, 2014, incorporated by reference herein in its entirety.

### TECHNICAL FIELD

The technical field of this disclosure is web browsers and documents displayed on such web browsers, particularly, systems and methods for annotating webpages.

### BACKGROUND OF THE INVENTION

Social media, such as Facebook and Twitter, allow people to interact to create, share, and exchange information and ideas. Although the interaction can include images to greatly enhance the interaction, the interaction remains primarily text based. Handling of the images within social media is limited. In one case, users can post a URL link on their social media account to allow other users to go to the same website that they are seeing in view images that they are seeing. In another case, users can upload image files stored locally on their personal computer. Unfortunately, users cannot easily browse the World Wide Web, comment on any images they may run across, and post the image with comments to their social media account.

Furthermore, information collected from the World Wide Web, such as text or images, loses its context. There is no way to tell who owns, created, or modified the information. Unfortunately, such lack of context hinders use of the collected information in research, collaboration, and commerce.

It would be desirable to have a system and method for annotating webpages that would overcome the above disadvantages.

### SUMMARY OF THE INVENTION

One aspect of the present invention provides a method for annotating webpages by a user of a research service, the method including: logging in to a research service account under an owner name associated with the user, the research service account including data storage for the user; displaying a website having a URL in a web browser on a personal device; capturing content from the website; generating a citation for the captured content; associating the content with linked information to form a research block, the linked information including the citation, the owner name, the URL, and a creation date; and storing the research block in the data storage remote from the personal device.

Another aspect of the invention provides a method for annotating webpages by a user of a research service, the method including: logging in to a research service account under an owner name associated with the user, the research service account including Backpack data storage for the user; entering a URL for a website in a web browser on a personal device to capture content from the website; generating a citation for the captured content; associating the content with linked information to form a research block, the linked information including the citation, the owner name, the URL, and a creation date; and storing the research block in the Backpack data storage remote from the personal device.

Yet another aspect of the invention provides a method for annotating webpages by a user of a research service, the method including: logging in to a research service account under an owner name associated with the user, the research service account including data storage for the user; entering a URL for a website in a web browser on a personal device to capture content from the website; generating a citation for the captured content; associating the content with linked information to form a research block, the linked information including the citation, the owner name, the URL, and a creation date; and storing the research block in the data storage remote from the personal device.

Yet another aspect of the invention provides a device for annotating webpages with user input of a user, the device including: a user interface for receiving the user input; a processor coupled to the user interface; and a memory coupled to the processor. The memory contains programming code responsive to the user input to the user interface to: log in to a research service account under an owner name associated with the user, the research service account including data storage for the user; display a website having a URL in a web browser on a personal device; capture content from the website; generate a citation for the captured content; associate the content with linked information to form a research block, the linked information including the citation, the owner name, the URL, and a creation date; and store the research block in the data storage remote from the personal device.

Yet another aspect of the invention provides a system for annotating webpages, the system including: data storage; and a personal device having a user interface to receive user input of a user and being operably connected to communicate with the data storage, the data storage being remote from the personal device. The personal device is responsive to the user input to: log in to a research service account under an owner name associated with the user, the research service account including the data storage for the user; display a website having a URL in a web browser on the personal device; capture content from the website; generate a citation for the captured content; associate the content with linked information to form a research block, the linked information including the citation, the owner name, the URL, and a creation date; and store the research block in the data storage.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a block diagram of a system for annotating webpages in accordance with one embodiment of the present invention.

FIG. 2 is a user interface of web content displayed in a web browser of a personal device in accordance with the present invention.

FIG. 3 is a detail of a user interface of a commentary service add-in button with a drop-down box displayed in a web browser of a personal device in accordance with the present invention.

FIG. 4 is a user interface of a captured screenshot displayed in a commentary service browser window of a personal device in accordance with the present invention.

FIGS. 5A-5F are details of editing tools for use with a captured screenshot displayed in a commentary service browser window of a personal device in accordance with the present invention.

FIG. 6 is a user interface of a captured screenshot with annotations displayed in a commentary service browser window of a personal device in accordance with the present invention.

FIGS. 7A-7C are publication options screens displayed in a commentary service browser window of a personal device in accordance with the present invention.

FIG. 8 is a user interface of a confirmation screen displayed in a commentary service browser window of a personal device in accordance with the present invention.

FIGS. 9A & 9B are a user interface of a commentary service post screen and attribution detail view, respectively, displayed in a commentary service browser window of a personal device in accordance with the present invention.

FIG. 10 is a user interface of a user editing screen displayed in a commentary service browser window of a personal device in accordance with the present invention.

FIG. 11 is a user interface of a user home screen displayed in a commentary service browser window of a personal device in accordance with the present invention.

FIG. 12 is a user interface detail view of a drop-down index box displayed in a commentary service browser window of a personal device in accordance with the present invention.

FIG. 13 is a user interface of a single edited screenshot screen displayed in a commentary service browser window of a personal device in accordance with the present invention.

FIG. 14 is a user interface of a tag search results screen displayed in a commentary service browser window of a personal device in accordance with the present invention.

FIGS. 15A & 15B are a user interface of a user profile screen and a user profile edit screen, respectively, displayed in a commentary service browser window of a personal device in accordance with the present invention.

FIG. 16 is a user interface of an explore screen displayed in a commentary service browser window of a personal device in accordance with the present invention.

FIG. 17 is a user interface of user account drop-down list displayed in a commentary service browser window of a personal device in accordance with the present invention.

FIG. 18 is a user interface of user account history screen displayed in a commentary service browser window of a personal device in accordance with the present invention.

FIGS. 19A & 19B are a user interface of an earned accomplishments tab and a potential accomplishments tab, respectively, of a user account profile screen displayed in a commentary service browser window of a personal device in accordance with the present invention.

FIGS. 20A-20C are user interfaces of a website displayed in a web browser of a personal device in accordance with the present invention.

FIGS. 21A & 21B are a user interface of an edited screenshot screen displayed in a web browser of a personal device in accordance with the present invention.

FIG. 22 is a flowchart for a method of annotating webpages in accordance with one embodiment of the present invention.

FIG. 23 is a block diagram of a research block for use in a method for annotating webpages in accordance with one embodiment of the present invention.

FIG. 24 is a block diagram of user data categories for a method of annotating webpages in accordance with one embodiment of the present invention.

FIGS. 25A-25E are screenshots of a user interface on a personal device used in capturing content and forming a research block for a method of annotating webpages in accordance with one embodiment of the present invention.

FIGS. 26A-26C are screenshots of a user interface on a personal device used in capturing content and forming a research block for a method of annotating webpages in accordance with another embodiment of the present invention.

FIGS. 27A-27G are screenshots of a user interface of a Backpack for use in a method of annotating webpages in accordance with another embodiment of the present invention.

FIGS. 28A-28C are screenshots of a research block with linked information for use in a method of annotating webpages in accordance with another embodiment of the present invention.

FIGS. 29A & 29B are screenshots of a research block with linked information for use in a method of annotating webpages in accordance with another embodiment of the present invention.

FIG. 30 is a flowchart for a method of annotating webpages in accordance with one embodiment of the present invention.

Throughout the various figures, like reference numbers refer to like elements.

### DETAILED DESCRIPTION OF PRESENTLY PREFERRED EMBODIMENTS

The present invention provides a commentary service which can be used to automatically capture a screenshot of a website, edit the screenshot, and store the edited screenshot and remote storage associated with the commentary service. When a website associated with an edited screenshot is open, the user can retrieve the edited screenshot from the remote storage for display. Users can also add comments to the edited screenshot.

The present invention further provides a research service which can be used to form research blocks, which can be sent to others and modified while tracking the source of the research block and any modifications. The research blocks can be bought and sold on a research block exchange, or commissioned to meet a custom research scope. The market in research blocks can be analyzed to provide history and guidance on current and future prices.

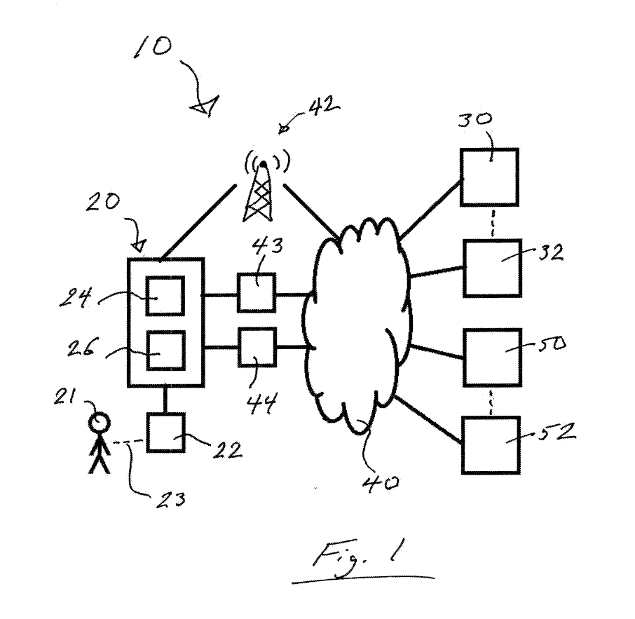

FIG. 1 is a block diagram of a system for annotating webpages in accordance with one embodiment of the present invention. The system 10 includes a personal device 20 and commentary service remote storage 30. The personal device 20 can have a user interface 22 to receive user input 23 from a user 21 and can be operably connected to communicate with the commentary service remote storage 30. Exemplary personal devices 20 include personal computers, tablet computers, portable computers, smart phones, and the like. The user interface 22 can be any user interface operable to display graphical information and to receive input from a user, such as a computer screen/mouse/keyboard combination on a personal computer, a touch screen on a tablet computer or smart phone, or the like. The personal device 20 can also include a processor 24 coupled to the user interface 22 and memory 26 coupled to the processor 24. The memory 26 can contain programming code responsive to the user input 23 to the user interface 22 to carry out a method of annotating webpages from the personal device 20.

In one embodiment, the personal device 20 communicates with the commentary service remote storage 30 over the Internet 40. The personal device 20 can be connected to the Internet 40 through a cellular system 42, a Wi-Fi node 43, a DSL modem 44, or the like. The system 10 can also include a commentary service hardware server 32 operably connected to communicate with the commentary service remote storage 30 and other parts of the system 10 over the Internet 40 and/or directly. The system 10 can also include third-party servers 50 and third-party storage 52 connected to communicate with other parts of the system 10 over the Internet 40 and/or directly. Although illustrated as single components, the various components of the system 10 can be distributed as a number of components to provide the desired functionality, capacity, and capability desired for a particular application. The system 10 can include additional memory and/or hardware servers to store data and computer code, processors to carry out instructions of the computer code, and communication hardware/software as required to carry out a method of annotating webpages from a personal device. Those skilled in the art will appreciate that the system 10 is an example and that any number of other communication configurations can be used to carry out the method of annotating webpages from a personal device described.

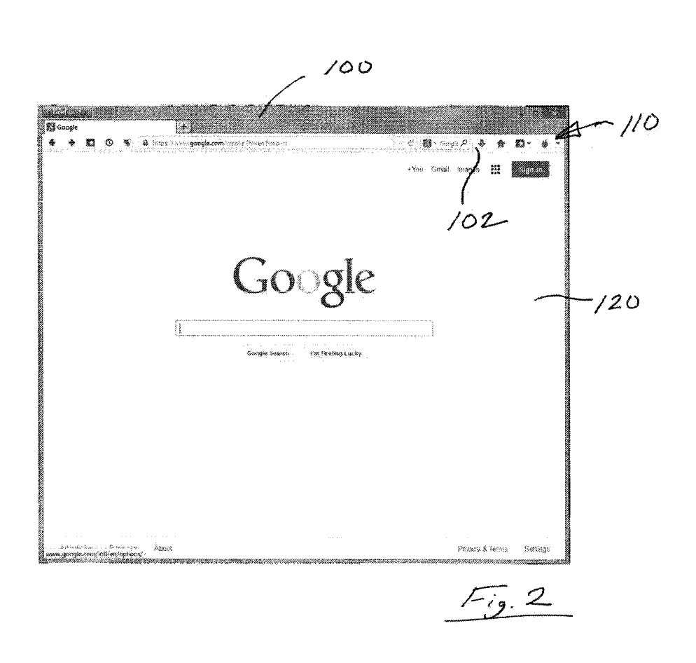

FIG. 2 is a user interface of web content displayed in a web browser of a personal device in accordance with the present invention. In this example, the web browser 100 is the Firefox web browser open on a personal device (not shown). A commentary service add-in button 110 is displayed on the navigation toolbar 102 of the web browser 100. The web content 120 in this example is the homepage for the Google website at www.Google.com. Those skilled in the art will appreciate that the web browser can be any software application operable to retrieve and present information resources written in HTML or other markup language on the World Wide Web, private network Web servers, file systems, or the like. Exemplary web browsers include Google Chrome, Mozilla Firefox, Internet Explorer, Opera, and Safari.

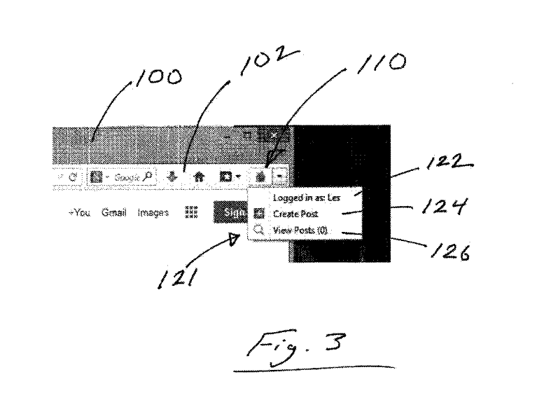

FIG. 3 is a detail of a user interface of a commentary service add-in button with a drop-down box displayed in a web browser of a personal device in accordance with the present invention. In this embodiment, actuation of the commentary service add-in button 110 displays a drop-down box 121 including commentary service login button 122, a commentary service Web Edit button 124, and a commentary service Show Annotation button 126. The commentary service Web Edit button 124, when actuated, captures a screenshot of the web content 120, opens a commentary service browser window in the web browser 100, and displays the screenshot in the commentary service browser window. The commentary service login button 122 can include user identity information to indicate the name of the user who is logged in to the commentary service and, when actuated, can display the commentary service home page of the user in the web browser 100. The commentary service Show Annotation button 126 can include an indication of the number of edited screenshots associated with the website 120 and, when actuated, can retrieve one or more of the edited screenshots from commentary service remote storage and display one or more of the edited screenshots in the web browser 100. Those skilled in the art will appreciate that the drop-down box 121 can include any buttons or information desired for a particular application.

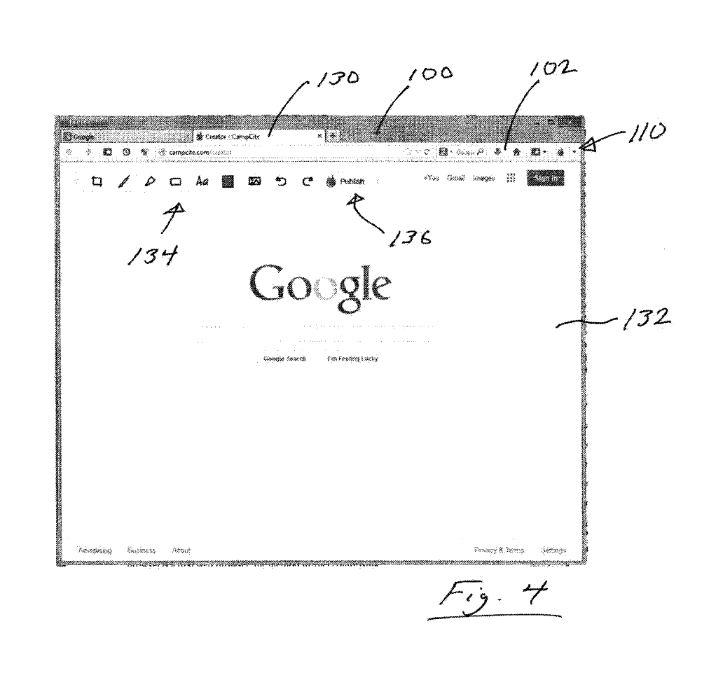

FIG. 4 is a user interface of a captured screenshot displayed in a commentary service browser window of a personal device in accordance with the present invention. The captured screenshot 132 automatically appears in the commentary service browser window 130 in the web browser 100 when the commentary service Web Edit button (not shown) is actuated. The commentary service browser window includes editing tools 134, which can be used to edit the captured screenshot 132, and a commentary service Web Publish button 136, which can be used to save the edited screenshot associated with the website to commentary service remote storage. In this example, the commentary service browser window 130 is displayed as a tab within the web browser 100. In another example, the commentary service browser window can open as a separate window on the personal device.

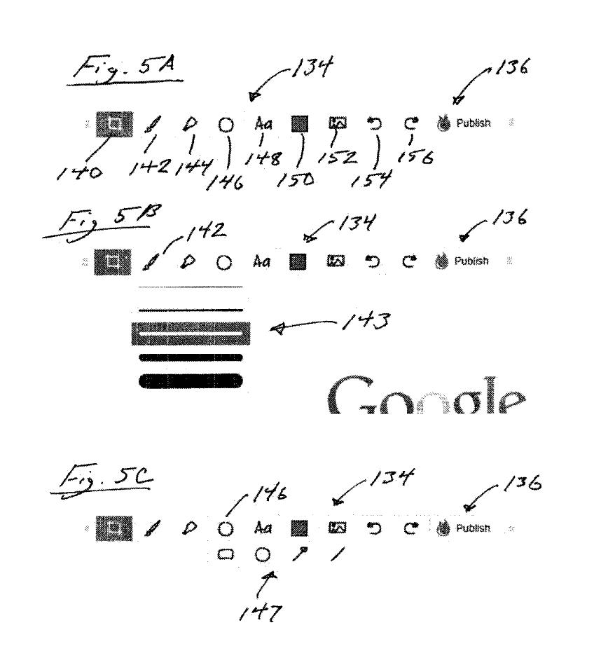

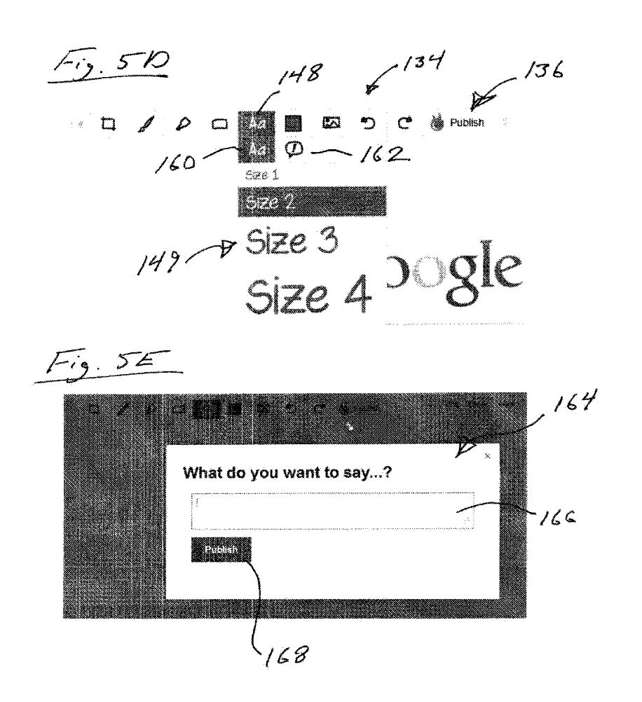

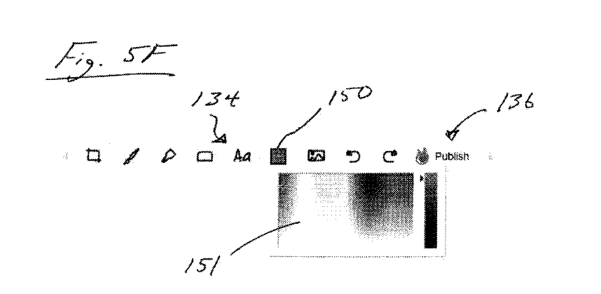

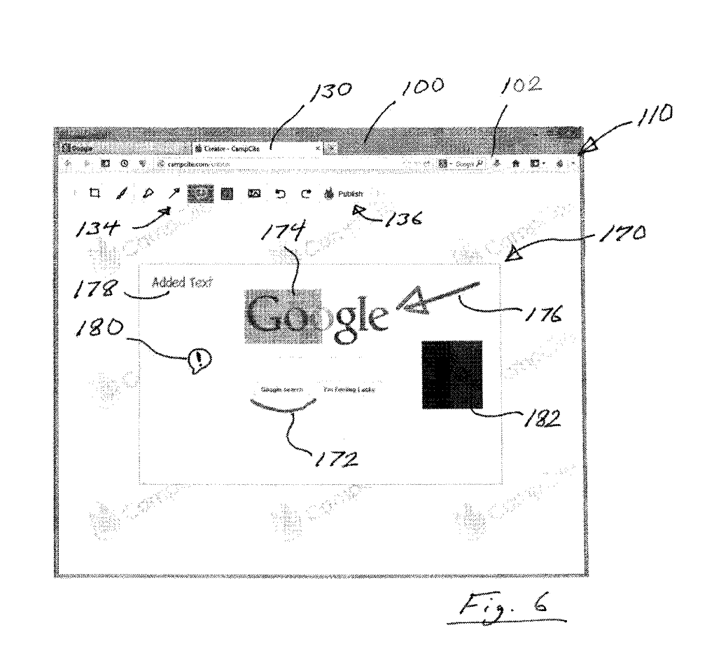

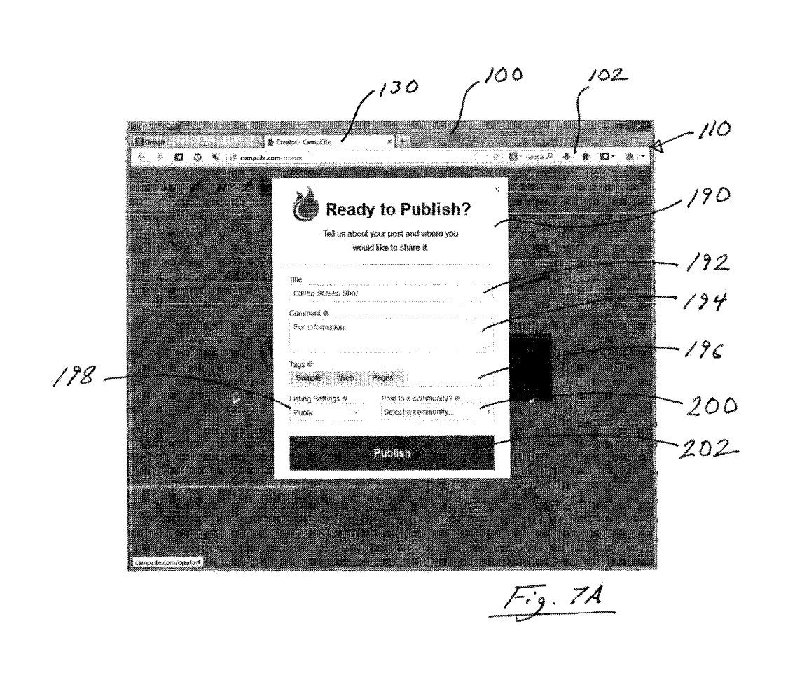

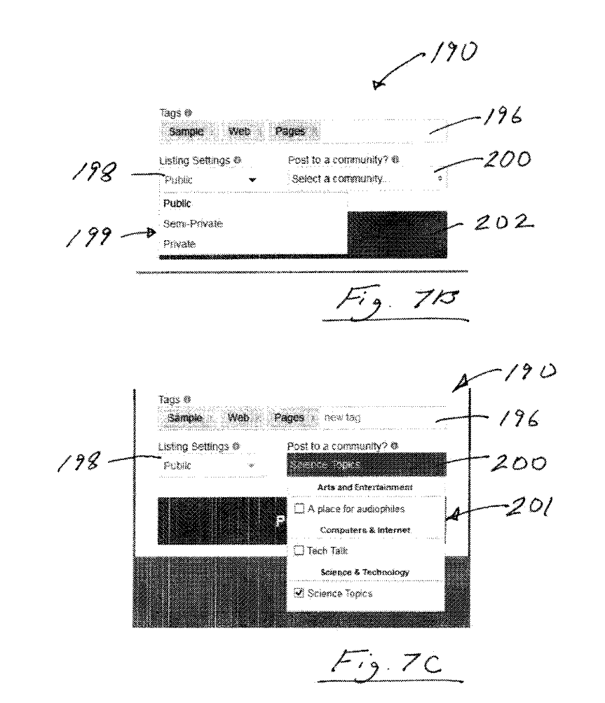

FIGS. 5A-5F are details of editing tools for use with a captured screenshot displayed in a commentary service browser window of a personal device in accordance with the present invention.

Referring to FIG. 5A, the editing tools 134 include a cropping tool 140, pen tool 142, highlight tool 144, figure tool 146, text tool 148, color selection tool 150, image selection tool 152, reverse action tool 154, and repeat action tool 156. The cropping tool 140 allows selection of a portion of the captured screenshot and cropping to the selected portion. The highlight tool 144 allows semi-transparent color highlighting the portion of the captured screenshot. The image selection tool 152 allows a graphic image from a file on the personal device to be embedded in the captured screenshot. The reverse action tool 154 allows reversal of the prior editing action and the repeat action tool 156 allows restoration of a previously reversed editing action.

Referring to FIG. 5B, the pen tool 142 allows freehand line drawings to be added to the captured screenshot. Hovering the mouse pointer over the pen tool 142 displays a line width option drop-down box 143, from which a particular line width can be selected using the mouse pointer.

Referring to FIG. 5C, the figure tool 146 allows pre-configured geometric figures to be added to the captured screenshot. Hovering the mouse pointer over the figure tool 146 displays a geometric figure option drop-down box 147, from which a particular geometric figure, such as a box, circle, arrow, or line, can be selected using the mouse pointer.

Referring to FIG. 5D, the text tool 148 allows user selected text to be added to the captured screenshot. Hovering the mouse pointer over the text tool 148 displays a text size option drop-down box 147, from which a particular text size can be selected using the mouse pointer. Hovering the mouse pointer over the text tool 148 also displays a hidden comment box tool 162, which opens a text input box when selected with the mouse pointer. Referring to FIG. 5E, the text input box 164 opens in front of the captured screenshot, and includes a text input box 166 and the publication button 168. The user can enter text in the text input box 166 and actuate the publication button 168 to annotate the captured screenshot with hidden text. A hidden text indicator is displayed on the captured screenshot and the associated hidden text is displayed when the mouse pointer hovers over the hidden text indicator.

Referring to FIG. 5F, the color selection tool 150 allows a particular color to be used in the other editing tools, such as the pen tool 142, highlight tool 144, figure tool 146, and text tool 148, for example. Hovering the mouse pointer over the color selection tool 150 displays a color selection drop-down box 151, from which a particular color can be selected using the mouse pointer.

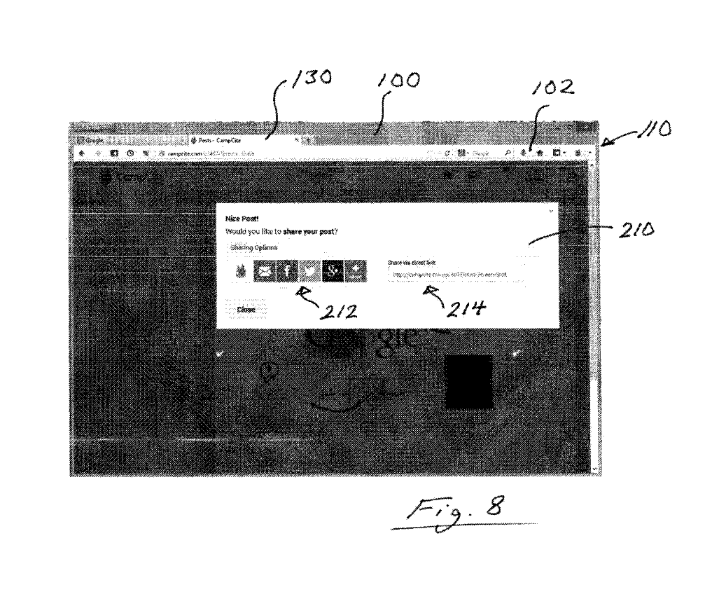

FIG. 6 is a user interface of a captured screenshot with annotations displayed in a commentary service browser window of a personal device in accordance with the present invention. The captured screenshot has been annotated into the edited screenshot 170 with the editing tools 134. A portion of the captured screenshot has been cropped to the edited screenshot 170 through the use of the cropping tool. A freehand curve 172 has been added with the pen tool 142. A highlight 174 has been added with the highlight tool. A geometric FIG. 176, in this example an arrow, has been added with the figure tool. Text 178 has been added with the text tool. A hidden text indicator 180 has been added with the hidden comment box tool, so that hovering the mouse pointer over the hidden text indicator 180 will display text attached to the edited screenshot 170, but not shown. A graphic image 182 from a file on the personal device has been added with the image selection tool. The commentary service Web publish button 136, when actuated, saves the edited screenshot 170 associated with the website to commentary service remote storage.

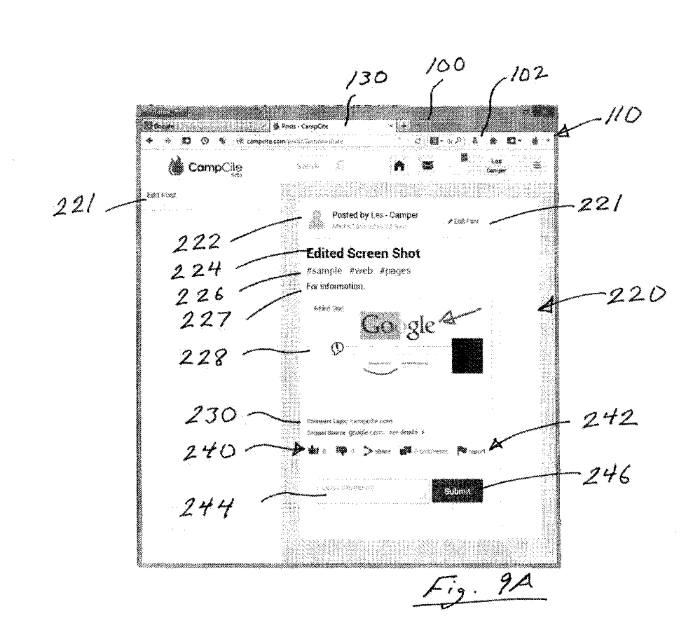

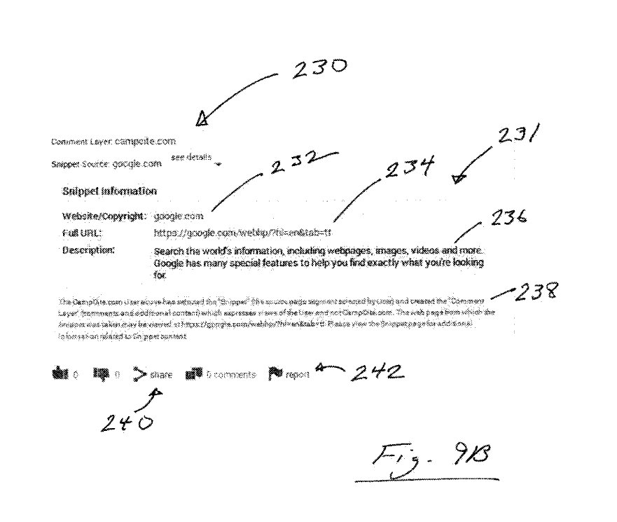

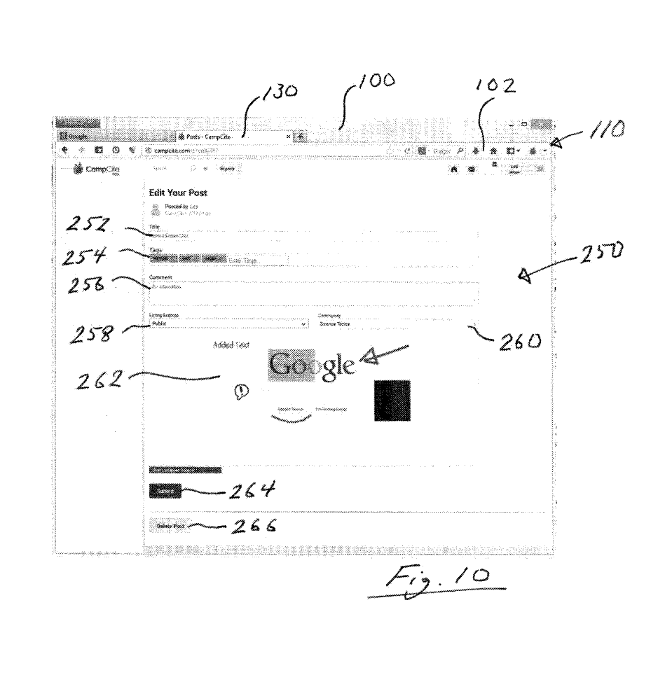

FIGS. 7A-7C are publication options screens displayed in a commentary service browser window of a personal device in accordance with the present invention. In this embodiment, actuating the commentary service Web publish button opens the publication options screen 190 as an overlay on the commentary service browser window 130. In another embodiment, actuating the commentary service Web publish button automatically saves the edited screenshot 170 associated with the website to commentary service remote storage in accordance with predetermined parameters.

Referring to FIG. 7A, the publication options screen 190 can include fillable information fields for the user to enter information to be associated with the edited screenshot. The publication options screen 190 can include a title field 192 for titling the edited screenshot, a comment post field 194 for the posting user to add comments related to the edited screenshot, and a tag field 196 for entering tags to be used in indexing the edited screenshot. Referring to FIG. 7B, the publication options screen 190 can also include a listing settings box 198 including a pull-down menu 199 which determines the accessibility of the edited screenshot, i.e., whether the edited screenshot is to be public, semi-private (available to selected users), or private (available only to the user creating the edited screenshot). Referring to FIG. 7C, the publication options screen 190 can also include a community selection box 201 which allows the user to determine in which communities within the commentary service the edited screenshot is to be posted.

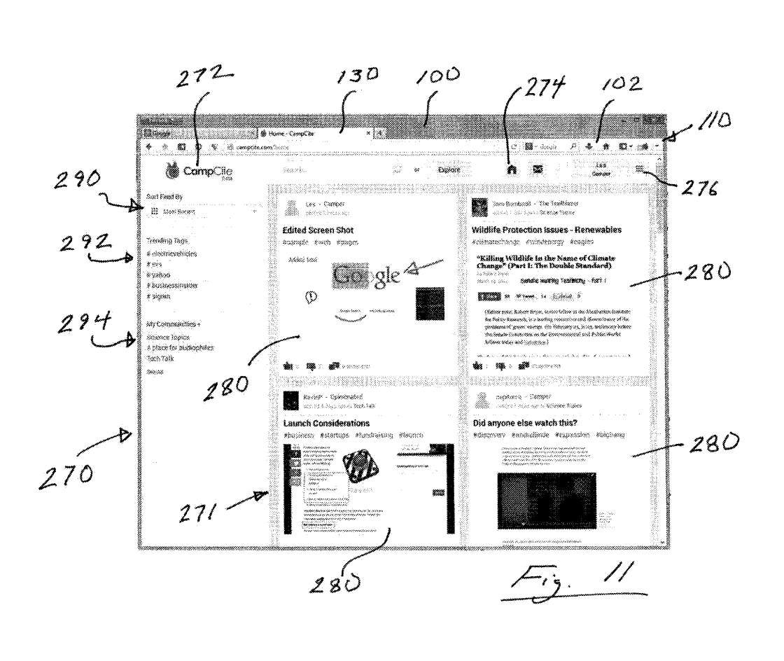

Referring to FIG. 7A, the publication options screen 190 can also include a final publication button 202 which, when actuated, saves the edited screenshot associated with the website to commentary service remote storage after the user has completed the desired fillable information fields on the publication options screen 190. FIG. 8 is a user interface of a confirmation screen displayed in a commentary service browser window of a personal device in accordance with the present invention. In one embodiment, actuating the final publication button can display a confirmation screen 210. The confirmation screen 210 can also include social media buttons 212, which can further publish the edited screenshot to other social media sites, such as Facebook, Twitter, Google Plus, or the like. The confirmation screen 210 can also include a share button 214, which in one embodiment can e-mail the web link of the saved edited screenshot (i.e., the URL for the saved edited screenshot stored on the commentary service remote storage) to other users, or which in another embodiment can e-mail the web link of the saved edited screenshot to the user himself for forwarding to other parties.

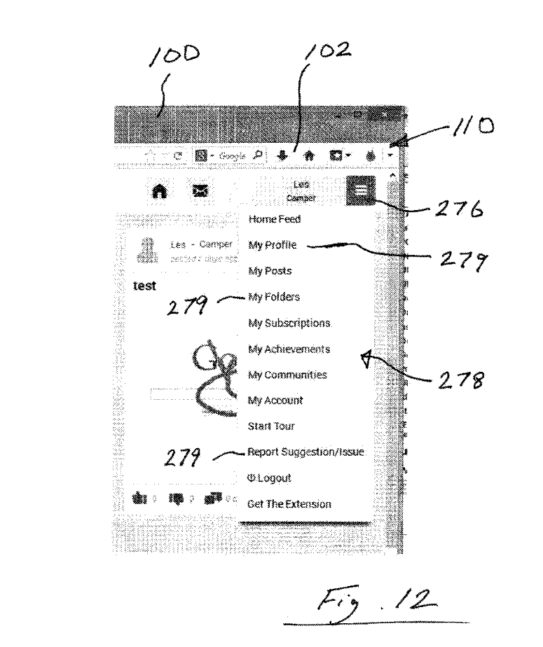

FIGS. 9A & 9B are a user interface of a commentary service post screen and attribution detail view, respectively, displayed in a commentary service browser window of a personal device in accordance with the present invention.

Referring to FIG. 9A, the edited screenshot as-posted screen 220 can be displayed in a commentary service browser window of a personal device when the close button on the confirmation screen is actuated. The edited screenshot as-posted screen 220 can include a user identifier 222, an edited screenshot title 224, edited screenshot tag buttons 226 (searchable by clicking on a particular tag), an edited screenshot comment post 227, an edited screenshot image 228, edited screenshot attributions 230, edited screenshot popularity markers 240 (indicating a number of popularity votes, linking, comments, or the like), edited screenshot report button 242 (allowing any user to report unlawful activity, trademark problems, spam, or the like within the edited screenshot), a user comment field 244, and a user comment submit button 246 (allowing any user to post user comments about the edited screenshot). The edited screenshot as-posted screen 220 can also include one or more edit post buttons 221, which allows the user to open a post editing screen.

Referring to FIG. 9B, the attribution detail 231 appears on the edited screenshot as-posted screen 220 when actuating a detail button associated with the edited screenshot attributions 230. The attribution detail 231 can include an originating website name 232, an originating website URL 234, and an originating website description 236, all for the website from which the edited screenshot originated. The attribution detail 231 can also include construction information 258 explaining that the user selects the source page segment and creates comments and additional content which express views of the user and not the commentary service.

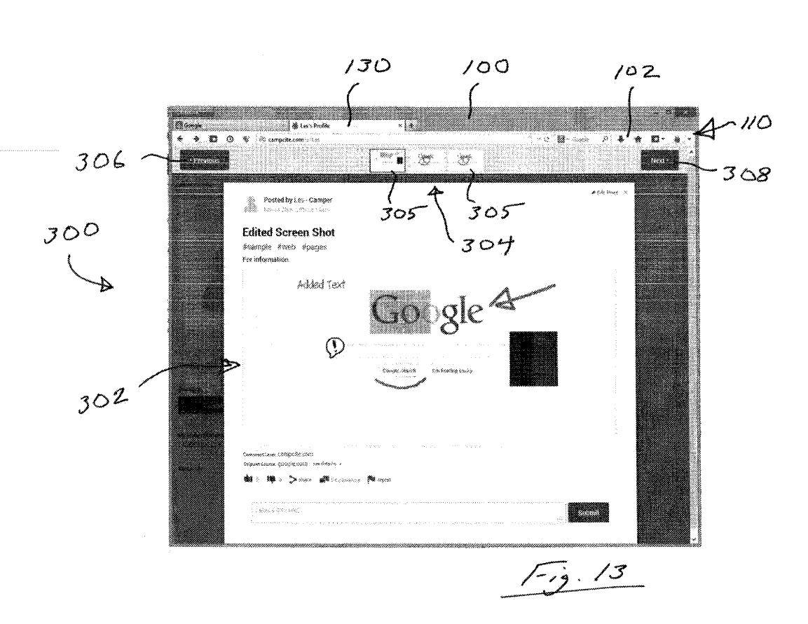

FIG. 10 is a user interface of a user editing screen displayed in a commentary service browser window of a personal device in accordance with the present invention. The user editing screen 250 can be displayed in a commentary service browser window of a personal device when the edit post button on the edited screenshot as-posted screen is actuated.

The user editing screen 250 can include fillable information fields for the user to enter or modify information associated with the edited screenshot. The user editing screen 250 can include a title field 252 for editing the title of the edited screenshot, a tag field 254 for editing tags to be used in indexing the edited screenshot, and a comment post field 256 for editing comments related to the edited screenshot. The user editing screen 250 can also include a listing settings box 258 to edit the accessibility of the edited screenshot, i.e., whether the edited screenshot is to be public, semi-private (available to selected users), or private (available only to the user creating the edited screenshot). The user editing screen 250 can also include a community selection box 260 to edit in which communities within the commentary service the edited screenshot is to be posted. The user editing screen 250 can also include a graphic image of the edited screenshot 262, a submit button 264 to allow the user to save the edited information on the user editing screen 250, and a delete button 2662 allow the user to delete the posted edited screenshot if desired.

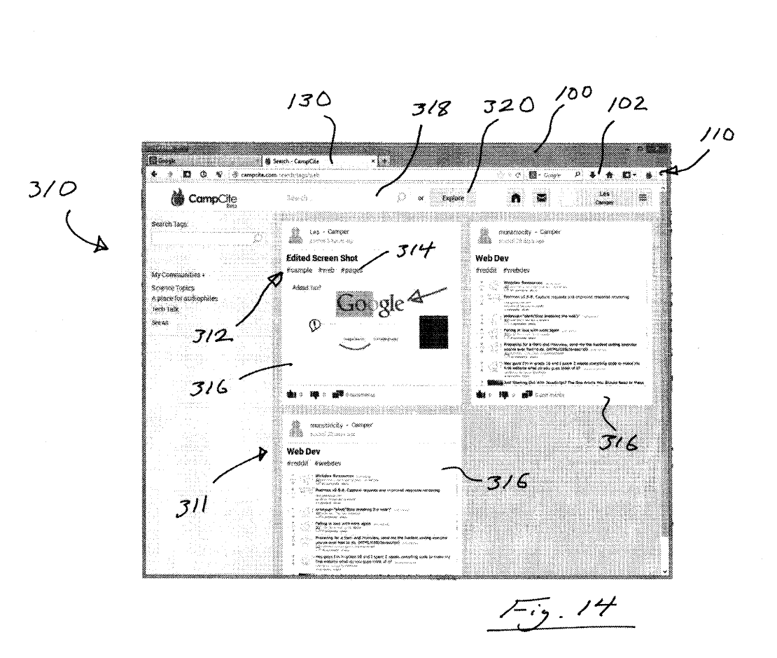

FIG. 11 is a user interface of a user home screen displayed in a commentary service browser window of a personal device in accordance with the present invention. Once the user has signed and with the commentary service, the user can access the user home screen 270 by actuating the commentary service logo button 272, the home button 274, the commentary service add-in button 110, or a home feed selection in the drop-down index box 276. The user home screen 270 can include a multiple display portion 271, which displays a number of edited screenshots 280 that are stored in the commentary service remote storage. The edited screenshots 280 can be sorted out as desired by the user, using a screenshot sort selection box 290, which can include sort options such as most recent, most popular, most changed, or the like. The user home screen 270 can also include a trending tag display 292, which displays tags associated with edited screenshots that are stored in the commentary service remote storage and are most active, i.e., being most added and/or accessed by users within the commentary service. Actuating one of the tags within the trending tag display 292 displays a tag search screen with edited screenshots labeled with the actuated tag, e.g., actuating a #yahoo tag displays a #yahoo tag search screen with edited screenshots labeled with #yahoo. The user home screen 270 can also include a user community display 294, which displays communities to which the user is subscribed. Actuating one of the community names within the user community display 294 displays a community home screen with edited screenshots for the actuated community name, e.g., actuating a Science Topics community name displays a Science Topics community home screen with edited screenshots posted to the Science Topics community.

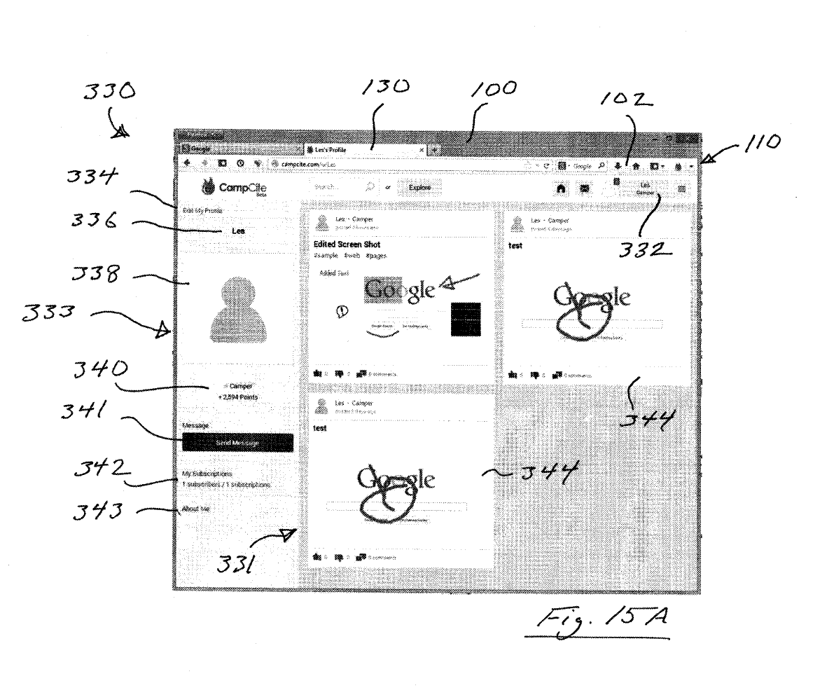

FIG. 12 is a user interface detail view of a drop-down index box displayed in a commentary service browser window of a personal device in accordance with the present invention. Actuating the drop-down index box 276 displays a user option drop-down box 278 listing user options 279. Actuating one of the user options 279 shifts the user interface in the commentary service browser window to the particular user option selected, e.g., actuating the Home Feed user option displays the user home screen.

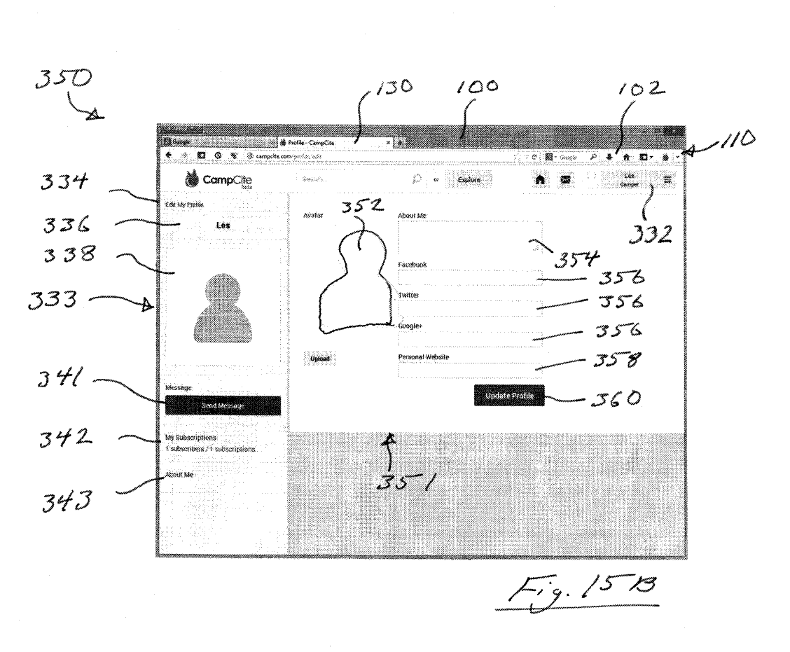

FIG. 13 is a user interface of a single edited screenshot screen displayed in a commentary service browser window of a personal device in accordance with the present invention. Actuating one of the edited screenshots in a multiple edited screenshot screen, such as clicking on one of the edited screenshots 280 in the multiple display portion 271 of the user home screen 270 as illustrated in FIG. 11. Those skilled in the art will appreciate that the single edited screenshot screen can be displayed by actuating any one of the edited screenshots in a multiple edited screenshot screen as desired for a particular application. In one embodiment, the single edited screenshot screen is overlaid on the multiple edited screenshot screen.

Referring to FIG. 13, the single edited screenshot screen 300 displays the single edited screenshot 302. The single edited screenshot screen 300 can also include a thumbnail display 304 with thumbnails 305 of the edited screenshots from the previous multiple edited screenshot screen. The single edited screenshot 302 displayed can be switched with the other edited screenshots from the previous multiple edited screenshot screen by actuating one of the thumbnails 305, or by use of the previous button 306 or next button 308 which displays an adjacent one of the edited screenshots from the previous multiple edited screenshot screen.

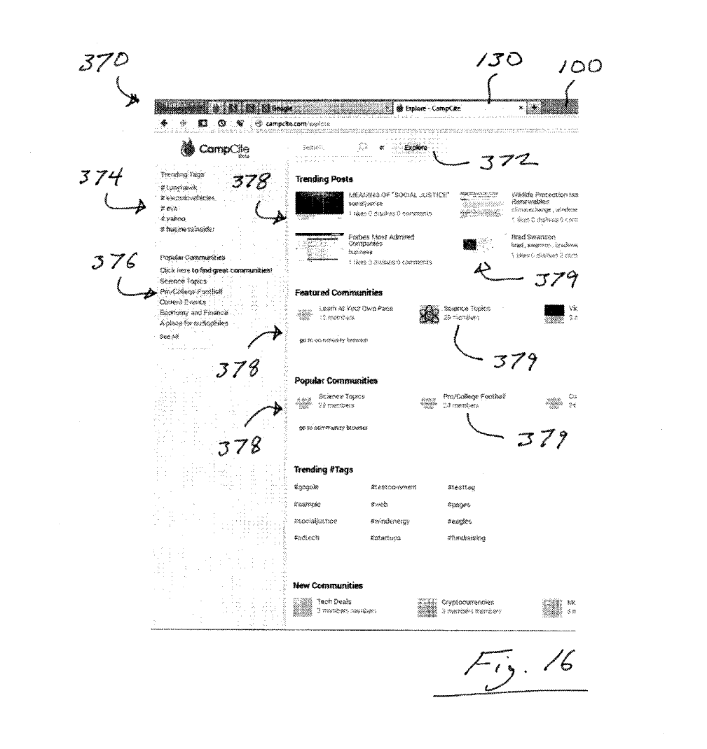

FIG. 14 is a user interface of a tag search results screen displayed in a commentary service browser window of a personal device in accordance with the present invention. The tag search results screen 310 displays edited screenshots stored on the commentary service remote storage which are indexed to the searched tag and to which the user has access.

In one embodiment, actuating a displayed tag anywhere within the commentary service will display the tag search results screen 310. For example, actuating an edited screenshot tag button 314 on a tag list 312 of an edited screenshot 316 in a multiple display portion 311 of a tag search results screen 310 will display a tag search results screen 310. In the example of FIG. 14, the #web screenshot tag button 314 was actuated to generate the tag search results screen 310, which includes edited screenshots 316 with tags including #web. In another embodiment, the edited screenshot tag can be entered in the search field 318 and a search performed to generate and display the tag search results screen 310. In yet another embodiment, an explore button 320 can be actuated to display an explore screen with one or more listings of edited screenshot tags currently in use, which can be actuated to display a tag search results screen.

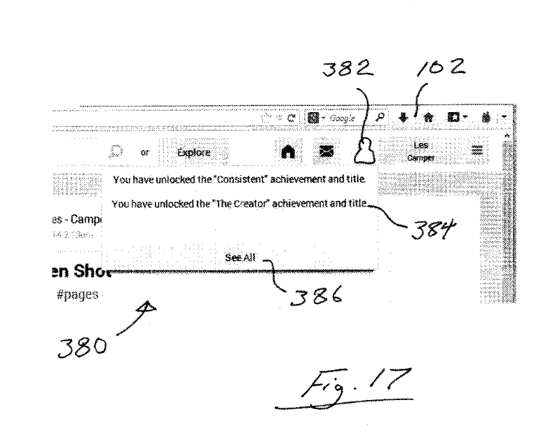

FIGS. 15A & 15B are a user interface of a user profile screen and a user profile edit screen, respectively, displayed in a commentary service browser window of a personal device in accordance with the present invention. The user profile screen 330 displays posts of edited screenshots from and information about the user of the commentary service. The user profile edit screen 350 allows editing of the information about the user of the commentary service.

Referring to FIG. 15A, actuating the user button 332 displays the user profile screen 330. The multiple display portion 331 of the user profile screen 330 displays edited screenshot 344 posted by the user. The user information portion 333 of the user profile screen 330 displays information about the user, such as username 336, user avatar 338, user commentary service rating 340, send message link 341, user subscription listing 342 and/or user description 343. The user information portion 333 can also include a profile edit button 334.

Referring to FIG. 15B, actuating the profile edit button 334 displays the profile edit screen 350. A profile edit portion 351 of the profile edit screen 350 can include input fields for a user description 354, social media addresses 356, and/or a personal website address 358. The profile edit portion 351 can also include an avatar display 352 into which a graphical user avatar can be uploaded from a file. The profile edit portion 352 can also include an update profile button 360 which, when actuated, saves the user information to the commentary service remote storage.

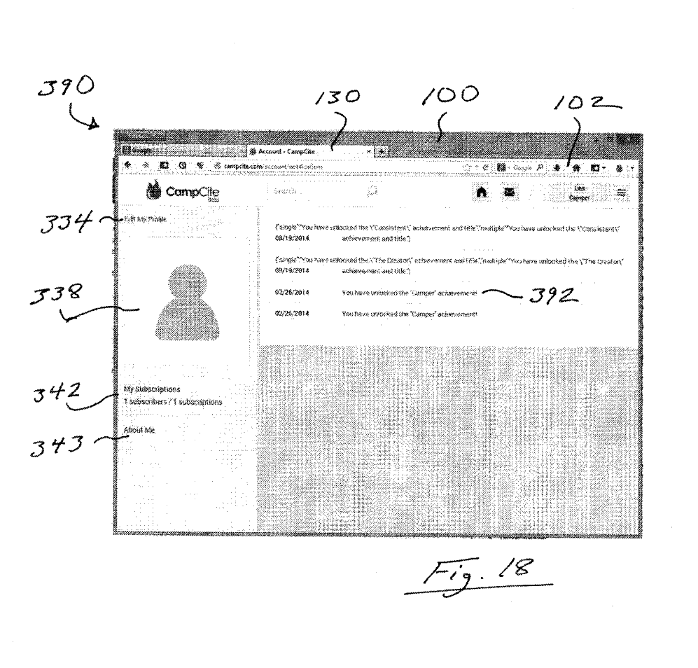

FIG. 16 is a user interface of an explore screen displayed in a commentary service browser window of a personal device in accordance with the present invention. Actuating the explore button 372 displays the explore screen 370. The explore screen 370 can include lists, such as a trending tag list 374 which includes tags indicating the most activity on the commentary service and a popular community list 376 which includes communities on the commentary service having the greatest number of members. The explore screen 370 can also include topic groups 378 organized by topics such as trending posts, featured communities, popular communities, pending #tags, new communities, and the like. Topics 379 within the topic groups 378 can include graphics and additional information related to the particular topic listed.

Those skilled in the art will appreciate that ordering of content, such as tags, websites, communities, and the like, inside of and external to the commentary service can be measured as desired for a particular application for presentation and filtering of content. In one example, content can be ordered by the most active, i.e., being most added and/or accessed by users. In another example, content can be ordered by most popular, i.e., being most voted for and/or least voted against. In yet another example, content can be ordered by most highly rated, i.e., receiving highest numerical/starred user ratings. In yet another example, content can be ordered by expert rating, i.e., receiving highest numerical/starred ratings from general or subject matter experts. In one embodiment, the ordering of content can be used in presenting lists of content items, such as trending tag lists. In another embodiment, the user can use the ordering of content as a filter for presentation of search results when performing a search.

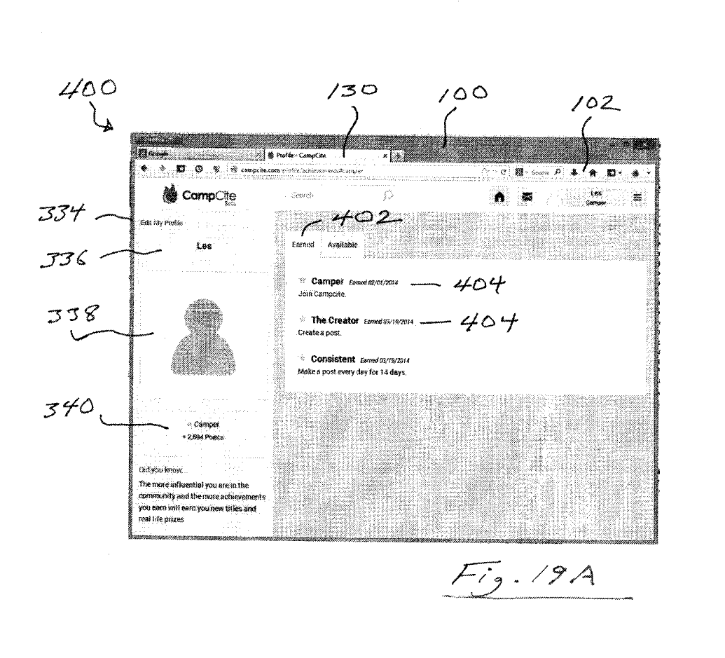

FIG. 17 is a user interface of user account drop-down list displayed in a commentary service browser window of a personal device in accordance with the present invention. Actuating the user avatar button 382 displays the user account drop-down list 380, which includes a list of achievement messages 384 concerning user achievements. The user account drop-down list 380 can also include See All button 386 which, when actuated, displays a user account history screen.

FIG. 18 is a user interface of user account history screen displayed in a commentary service browser window of a personal device in accordance with the present invention. Actuating the See All button on a user account drop-down list displays the user account history screen 390. The user account history screen 390 includes a list of user achievement messages 392, such as the date, particular achievement reach, and the like. Actuating a user achievement message 392 can display a user account profile screen.

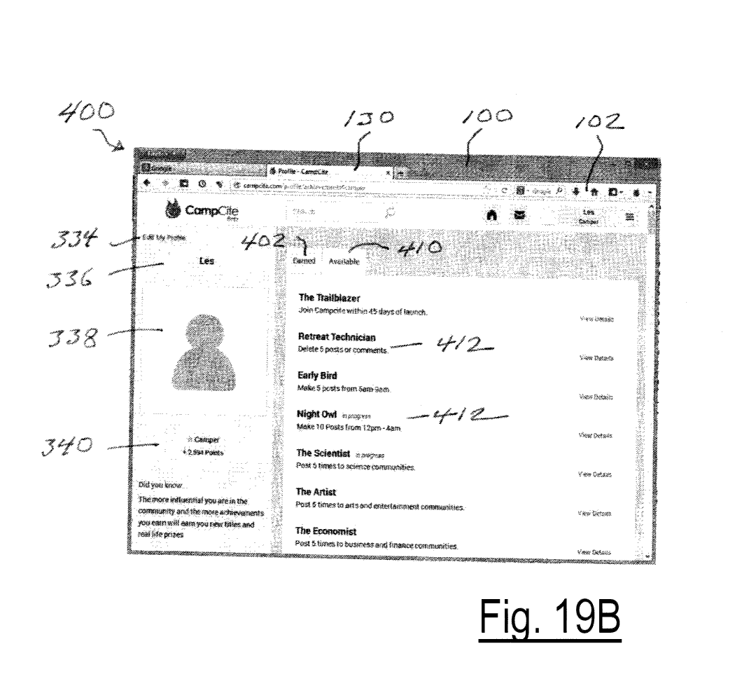

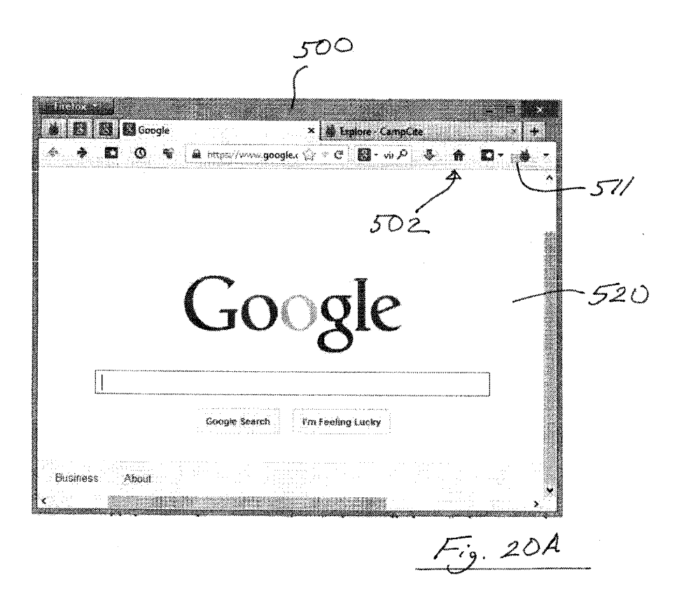

FIGS. 19A & 19B are a user interface of an earned accomplishments tab and a potential accomplishments tab, respectively, of a user account profile screen displayed in a commentary service browser window of a personal device in accordance with the present invention. Actuating a user achievement message on a user account history screen can display a user account profile screen 400. Referring to FIG. 19A, the earned accomplishments tab 402 on the user account profile screen 400 includes achievement items 404 obtained by the user, including information such as an achievement title, date earned, achievement details, and the like. Referring to FIG. 19B, the potential accomplishments tab 410 on the user account profile screen 400 includes potential achievement items available to the user, including information such as an achievement title, achievement requirements, and the like. The user account profile screen 400 can be toggled between the earned accomplishments tab 402 and the potential accomplishments tab 410 by actuating the tab which is not displayed.

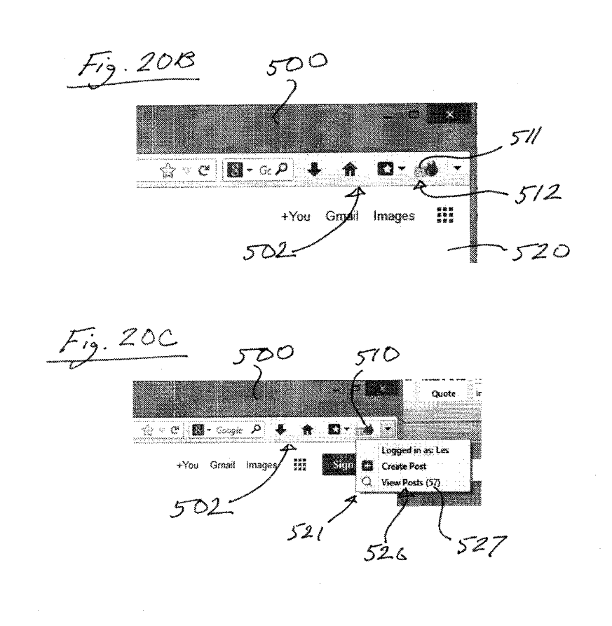

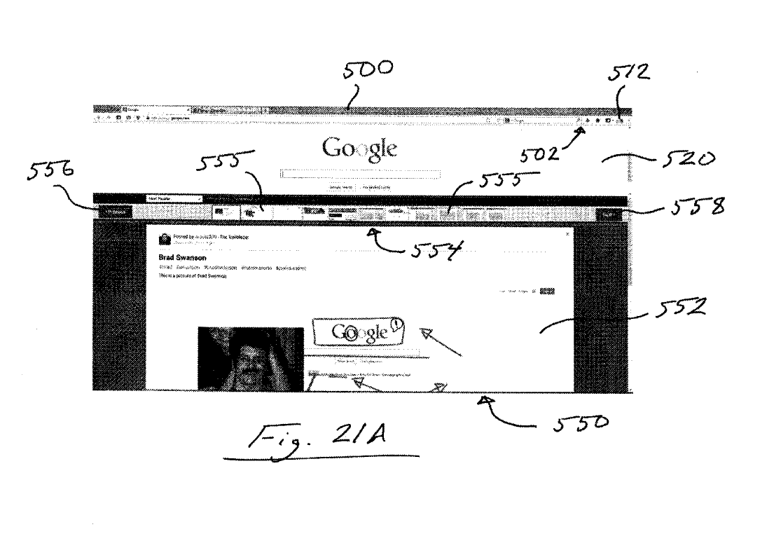

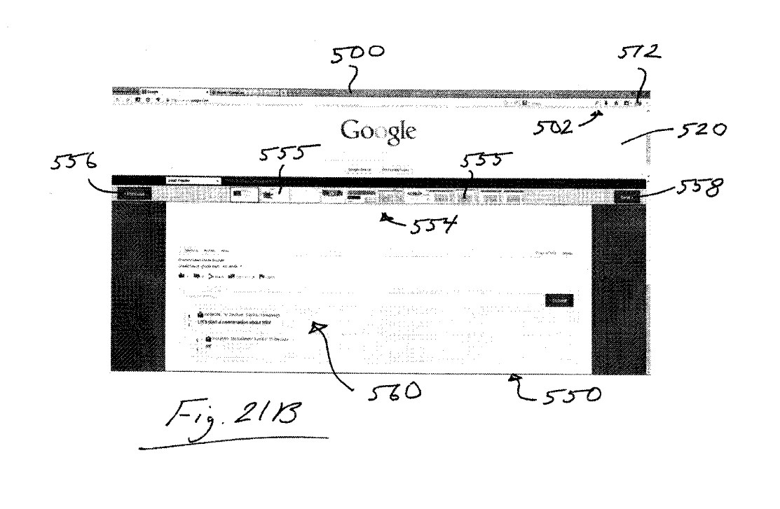

FIGS. 20A-20C are user interfaces of a website displayed in a web browser of a personal device in accordance with the present invention. In this example, the web browser 500 is the Firefox web browser open on a personal device (not shown). Referring to FIG. 20A, an Annotation indicator 511 is displayed on the navigation toolbar 502 of the web browser 500. The website 520 in this example is the homepage for the Google website at www.Google.com.

FIG. 20B illustrates detail of the Annotation indicator 511 displayed in the web browser 500, which indicates existence of an edited screenshot associated with the website and stored on the commentary service remote storage. In this example, the Annotation indicator 511 includes an edited screenshot counter 512 which indicates the number of edited screenshot associated with the website. In this example, the edited screenshot counter 512 displays the number 57 corresponding to 57 edited screenshots associated with the website stored on the commentary service remote storage. In one embodiment, the Annotation indicator 511 can function as a commentary service Show Annotation button when actuated to retrieve edited screenshot from the service remote storage and to display the edited screenshots associated with the website in the web browser.

FIG. 20C illustrates detail of a drop-down box 521 displayed in the web browser 500 when a commentary service add-in button 510 is actuated. The drop-down box 521 includes a commentary service Show Annotation button 526 with an edited screenshot counter 527, which indicates the number of edited screenshots associated with the website. In this example, the edited screenshot counter 527 displays the number 57 corresponding to 57 edited screenshots associated with the website stored on the commentary service remote storage. When actuated, the commentary service Show Annotation button 526 can retrieve one or more of the edited screenshots from commentary service remote storage and display one or more of the edited screenshots in the web browser 500.

FIGS. 21A & 21B are a user interface of an edited screenshot screen displayed in a web browser of a personal device in accordance with the present invention. Actuating a commentary service Show Annotation button, which can be a function of the edited screenshot counter 512, displays the edited screenshot screen 550 in the web browser 500. In this embodiment, the edited screenshot screen 550 is overlaid on the website 520, which remains functional, so that the website 520 and the edited screenshot 552 appear in different frames. In another embodiment, the edited screenshot screen can completely cover the website.

Referring to FIG. 21A, the edited screenshot screen 550 displays in edited screenshot 552. The edited screenshot screen 550 can also include a thumbnail display 554 with thumbnails 555 of additional edited screenshots associated with the website 520. The edited screenshot screen 550 displayed can be switched with the other edited screenshots associated with the website 520 by actuating one of the thumbnails 555, or by use of the previous button 556 or next button 558 which displays an adjacent one of the edited screenshots associated with the website 520. FIG. 21B illustrates the edited screenshot screen 550 with the edited screenshot 552 scrolled down to display the edited screenshot conversation 560 posted by users.

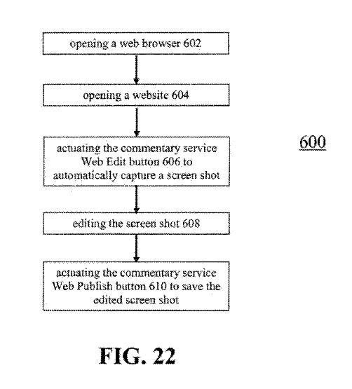

FIG. 22 is a flowchart for a method of annotating webpages from a personal device in accordance with one embodiment of the present invention. The method 600 can operate on a system as illustrated in FIG. 1.

Referring to FIG. 22, the method 600 can include opening a web browser 602 on the personal device, the web browser including a commentary service Web Edit button; and opening a website 604 in the web browser. Exemplary personal devices include personal computers, tablet computers, portable computers, and smart phones, and the like. Actuating the commentary service Web Edit button 606: to automatically capture a screenshot of the opened website; to open a commentary service browser window in the web browser, the commentary service browser window including editing tools and a commentary service Web Publish button; and to display the automatically captured screenshot in the opened commentary service browser window.

The method 600 can continue with editing the screenshot 608 with the editing tools within the commentary service browser window to generate an edited screenshot; and actuating the commentary service Web Publish button 610 to save the edited screenshot associated with the website to commentary service remote storage, the commentary service remote storage being remote from the personal device. The editing the screenshot 608 can take place at a location as desired for a particular application, i.e., the user can input changes/additions to a screenshot displayed on the personal device, but the changes to the screenshot are made at the personal device or the commentary service remote server. In one embodiment, the editing the screenshot 608 with the editing tools includes editing the screenshot with the editing tools on a commentary service remote server. In another embodiment, the editing the screenshot 608 with the editing tools includes editing the screenshot with the editing tools on the personal device. Exemplary editing tools include cropping tools, pen tools, highlight tools, figure tools, text tools, color selection tools, image selection tools, reverse action tools, repeat action tools, and the like. In one embodiment, the method 600 can further include displaying the website in the web browser after actuating the commentary service Web Publish button 610.

The edited screenshot can include various elements and the further processed. In one embodiment, the edited screenshot includes graphical elements and text elements. In another embodiment, when the edited screenshot includes graphical elements, the method 600 can further include obtaining optical character recognition text elements from graphical text within the graphical elements.

The method 600 can further include adding comments to the edited screenshot associated with the website. The comments can be text, images, sound, or a combination thereof. In one embodiment, adding comments can include adding comments from a personal or public comment library. In one example, comments can be added from a personal comment library of stored replies, i.e., replies which the user has found popular or persuasive in past commenting and has stored in the personal comment library for future use. In another example, comments can be added from a public comment library of popular replies, such as a library of replies voted as popular from past use in comments on the commentary service.

Adding comments can employ an argument assist tool for assistance to the user. In one embodiment, adding comments can include adding logically valid comments based on input from an argument assist tool, which can consist of tools such as neural net tools, rule set tools, and the like. In one embodiment, the argument assist tool can employ rules such as the legal rules of evidence, scientific methods, logic, rhetoric, and the like. In another embodiment, the argument assist tool analyzes prior comments associated with the edited screenshot to formulate the logically valid comments. In another embodiment, the argument assist tool can include a user searchable index of artifacts, such as axioms, maxims, aphorisms, proverbs, rules, principles, arguments (e.g., ad hominem), counter arguments, fallacies, laws, or the like, which can be used in formulating the logically valid comments.

The web browser can be prepared prior to opening the web browser 602 on the personal device. In one embodiment, the method 600 can further include registering with a commentary service linked to the commentary service Web edit button prior to the opening a web browser on the personal device. In another embodiment, the method 600 can further include installing a commentary service browser extension to the web browser before the opening a web browser on the personal device, the commentary service browser extension including computer code operable to display and enable the commentary service Web Edit button, the editing tools, and the commentary service Web Publish button in the web browser.

The method 600 can also include opening a second web browser on a second personal device; opening the website in the second web browser; indicating existence of the edited screenshot associated with the website on an Annotation indicator on the second web browser; and actuating a commentary service Show Annotation button on the second web browser: to retrieve the edited screenshot from the service remote storage; and to display the retrieved edited screenshot in the web browser. In one embodiment, the retrieved edited screenshot is displayed in the second web browser as an overlay to the website. In one embodiment, the second web browser is the same as the prior web browser and/or the second personal device is the same as the prior personal device. In another embodiment, the second web browser is different than the prior web browser and/or the second personal device is different than the prior personal device.

The system and method described in conjunction with FIGS. 1-22 above can also be structured to facilitate research, collaboration, and commerce among users. Research blocks can be formed from website content and metadata, such as screenshots, images, video, or text, by associating linked information with the content. The linked information can include an owner name, citation (such as creator, URL, and creation date), and block history if the research block is modified after creation. The research blocks can be stored in Backpack storage of a user, and then aggregated into a draft in draft storage. A research block can be sold and/or traded in a research block exchange, with the owner retaining ownership and the purchaser obtaining rights to copy the research block or with the owner transferring all ownership and rights in the research block to the purchaser.

In other embodiments, the linked information can include a citation, the URL and PreCite™ information including owner name, creation date and tracking information including block history if the research block is modified after creation. Research blocks can be added as Backpack items and stored in Backpack storage of a user, and then aggregated into a draft in draft storage. The research blocks can be added directly to a draft of which the user is an editor and stored in draft storage. Research blocks can simultaneously be added as a Backpack item and stored and to a draft and stored. Research blocks can simultaneously be shared via email or other social media and added as Backpack items and stored in Backpack storage of a user. Research blocks in a draft or post to which as user has access may be added as a Backpack items and stored in Backpack storage of a user. Single or multiple research blocks in a user's Backpack can be marked and copied to one or more users. Single or multiple research blocks in a user's Backpack can be marked and transferred to another user with the effect of changing ownership of the transferred block(s) to the recipient user and automatically removing the block(s) from the transferring user's Backpack storage. Single or multiple research blocks in a user's Backpack can be marked and deleted from the user's Backpack storage.

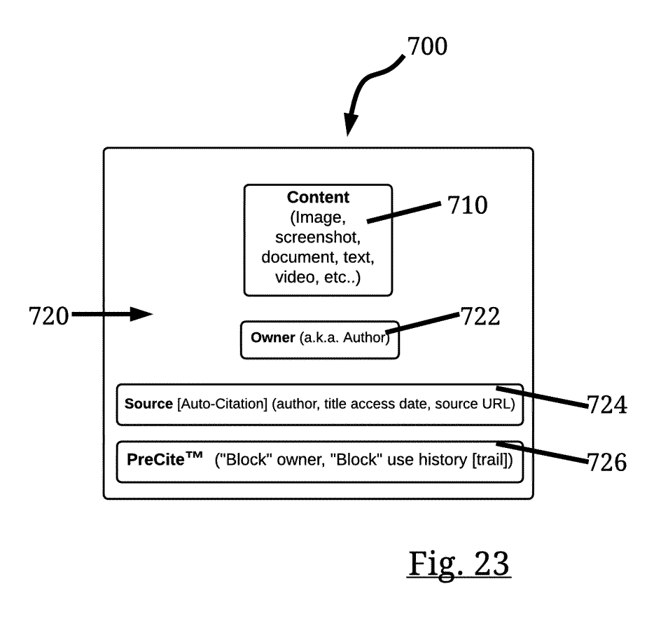

FIG. 23 is a block diagram of a research block for use in a method for annotating webpages in accordance with one embodiment of the present invention.

The research block 700 includes content 710 and linked information 720. Exemplary content 710 can include screenshots, images, text, documents, video, combinations thereof, or the like. In one embodiment, the content 710 is website content captured from a website displayed in a web browser on a personal device. The linked information 720 associated with the content 710 can include an owner name 722, a citation 724, and a block history 726. The owner name 722 identifies the owner of the research block, i.e., the initial author of the research block or another user to whom the ownership has been transferred by purchase or donation. In one example, the owner name 722 is the user ID for the research service on which the research block is stored. The citation 724 can include an author identifier, article title, source URL, generation date, and the like. In one embodiment, the citation 724 can be automatically formatted in accordance with the desired citation format, such as Simple Citation, APA, MLA, Chicago, Harvard, Vancouver, or the like. In one example, the desired citation format can be selected in the account settings for the user ID on the research service. The block history 726, also designated as PreCite™ tracking service, can include a history of the research block 700 indicating that the present research block 700 was derived from a series of prior research blocks. The listing for each of the prior research blocks can include the URL, owner, creation date, and the like for the prior research block. The block history 726 has a prior research block added each time a research block is altered by the owner or another user. Individual elements of the linked information 720 can be hyperlinked when displayed, so that the user can open a window linked to the particular element.

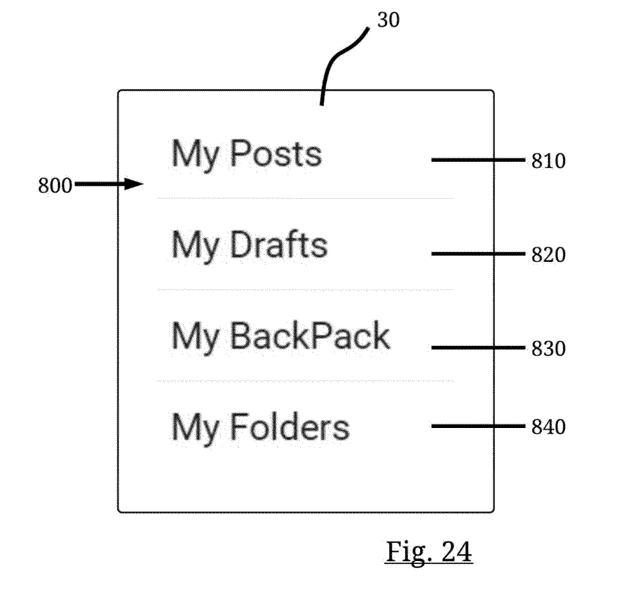

FIG. 24 is a block diagram of user data categories for a method of annotating webpages in accordance with one embodiment of the present invention. The user data can be stored in the commentary service remote storage 30 of FIG. 1 or other remote storage as desired for a particular application.

Referring to FIG. 24, the user data can be stored within user data categories 800, including posts data storage 810, drafts data storage 820, Backpack data storage 830, and folders data storage 840. Each of the posts in the posts data storage 810 can include one or more research blocks authored or co-authored by the user. Each of the posts in the posts data storage 810 can be published with viewing limitations on other users as desired by the posting user, such as public, unlisted, private, draft, or the like. The drafts data storage 820 include drafts of future posts which can be stored within the posts data storage 810 upon completion. The Backpack data storage 830 includes research blocks, which are created by the user or copied or transferred from another user. The folders data storage 840 includes posts for which a particular folder is designated, e.g., the posts within the folders data storage 840 can be divided by particular topic.

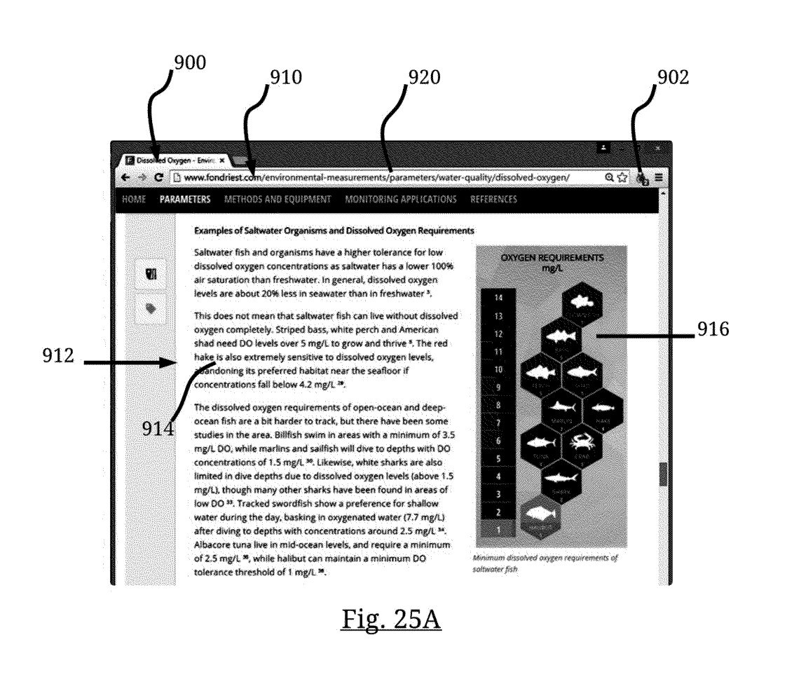

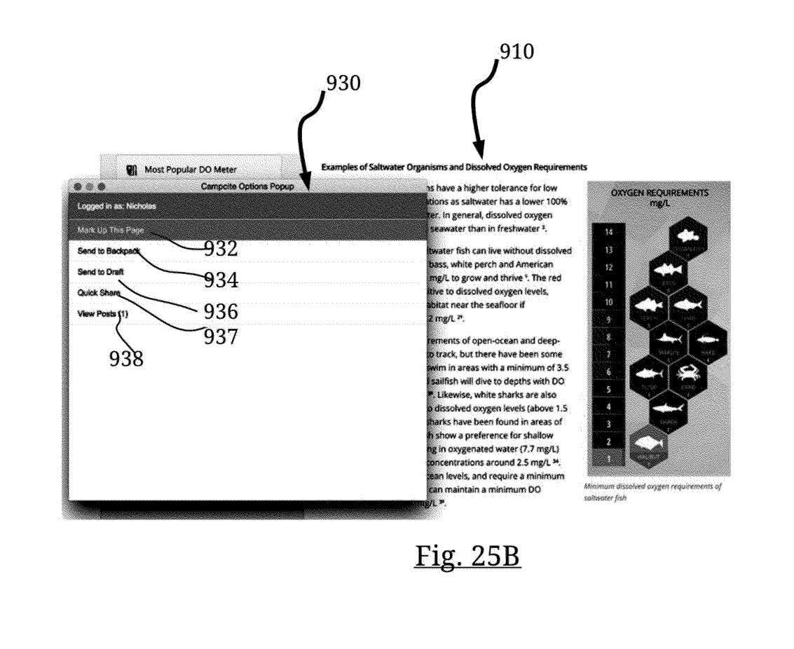

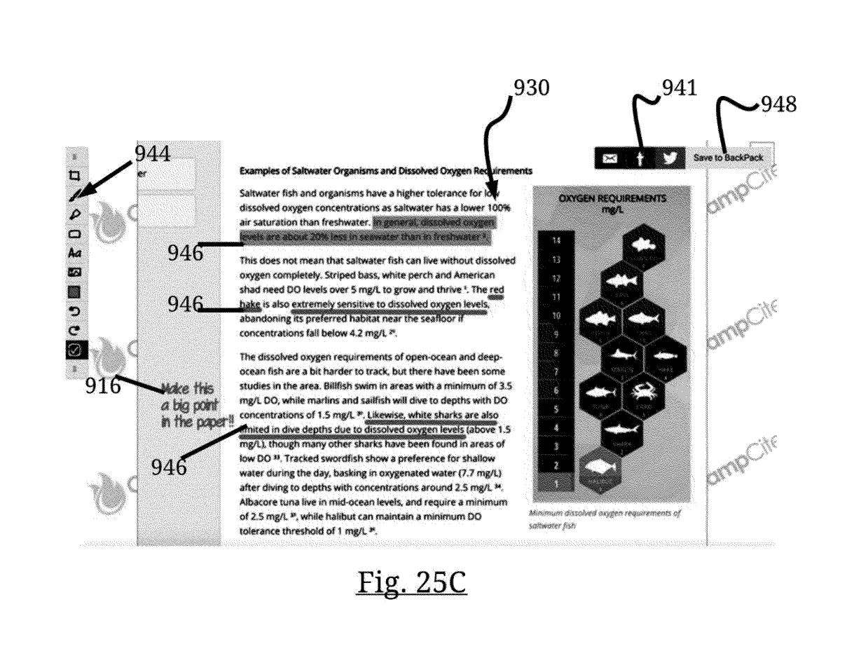

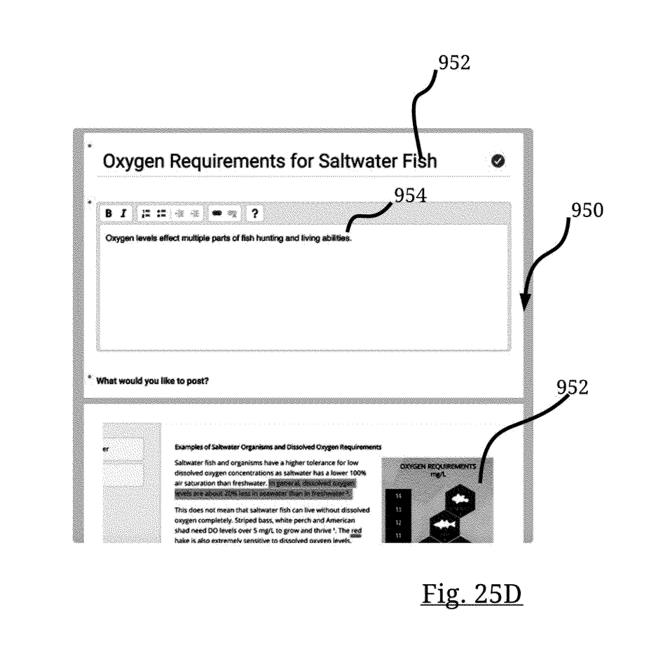

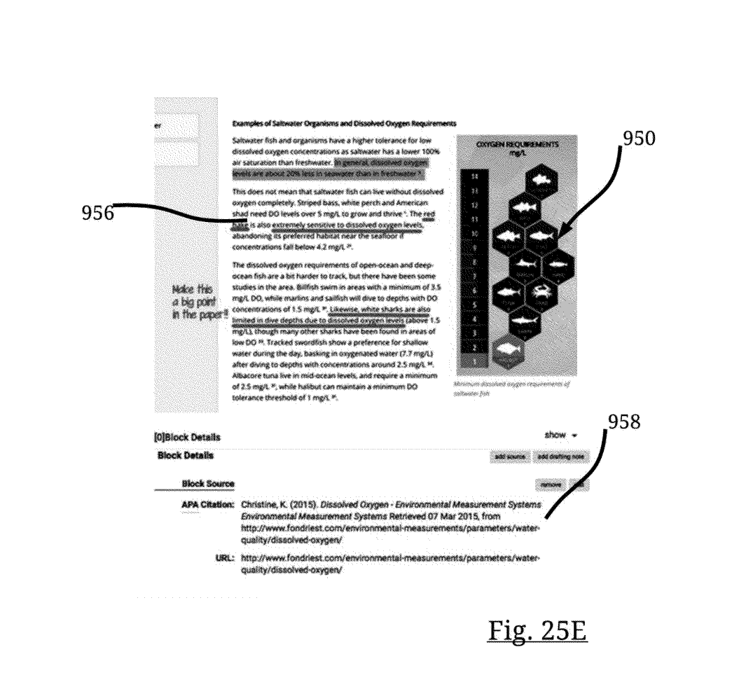

FIGS. 25A-25E are screenshots of a user interface on a personal device used in capturing content and forming a research block for a method of annotating webpages in accordance with one embodiment of the present invention. In this example, the content is captured by actuating a Research button on the web browser to capture a screenshot as content, and the screenshot can be edited with editing tools on the personal device.

Referring to FIG. 25A, the user is logged into a research service account. A website 910 having a URL 920 is displayed in a web browser 900 on a personal device (not shown). The web browser 900 includes a Research button 902 associated with the research service. The website 910 displays content 912 including a text portion 914 and an image portion 916. The user begins the process of capturing content from the website by actuating the Research button 902.

Referring to FIG. 25B, the actuation of the Research button 902 captures a screenshot of the website 910 and opens options box 930 in the web browser 900 overlaying the website 910. The options box 930 displays a number of options: Mark up This Page option 932; Send to Backpack option 934; Send to Draft option 936; Quick Share option 937; and View Posts option 938. The Mark up This Page option 932 can be used to edit the captured screenshot with editing tools on the personal device before storing the research block in Backpack data storage after associating the captured screenshot with linked information. The Send to Backpack option 934 can be used to store the research block in Backpack data storage after associating the captured screenshot with linked information. The Send to Draft option 936 can be used to send the captured screenshot to the drafts data storage as a draft post. The Quick Share option 937 can be used to send the captured screenshot to others by email or social networking sites such as Facebook or Twitter. The View Posts option 938 can be used to view posts associated with the website displayed in the web browser.

Referring to FIG. 25C, the actuation of the Mark Up This Page option 932 opens an editing page 940 on the personal device. The editing page 940 can display the captured screenshot 942 and editing tools 944. In this example, edits 946 have been made to the captured screenshot 942 with the editing tools 944. Various editing tools are discussed in conjunction with FIGS. 5A-5F. Referring to FIG. 25C, the editing page 940 also includes a Save to Backpack button 948. The editing page 940 can also include Quick Share buttons 941 to send the captured screenshot to others by email or social networking sites such as Facebook or Twitter.

Referring to FIGS. 25D & 25E, the actuation of the Save to Backpack button 948 opens a research block preparation page 950. The user can enter the research block title 952 and optional introduction 954. In another embodiment, the research service can automatically generate drafts of the research block title 952 and the optional introduction 954 from the information contained in the edited, captured screenshot 956. In this example, the research block preparation page 950 also displays the edited, captured screenshot 956 and linked information 958. Once the research block title 952 has been entered by the user, the user can save the research block.

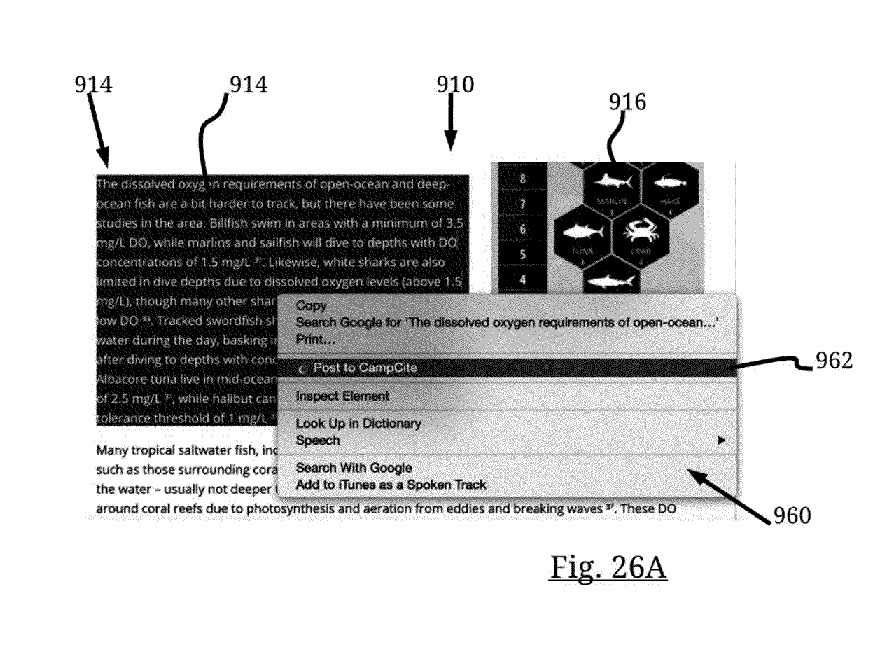

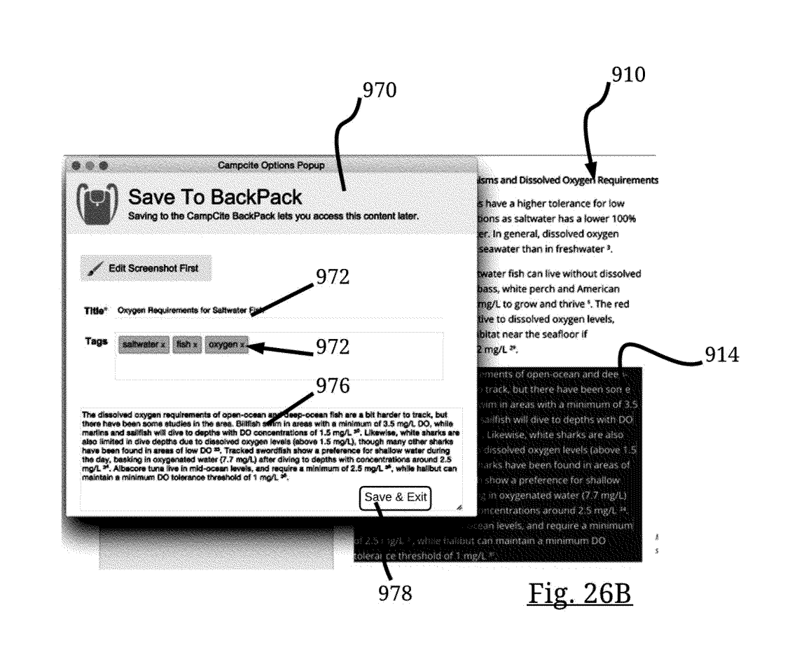

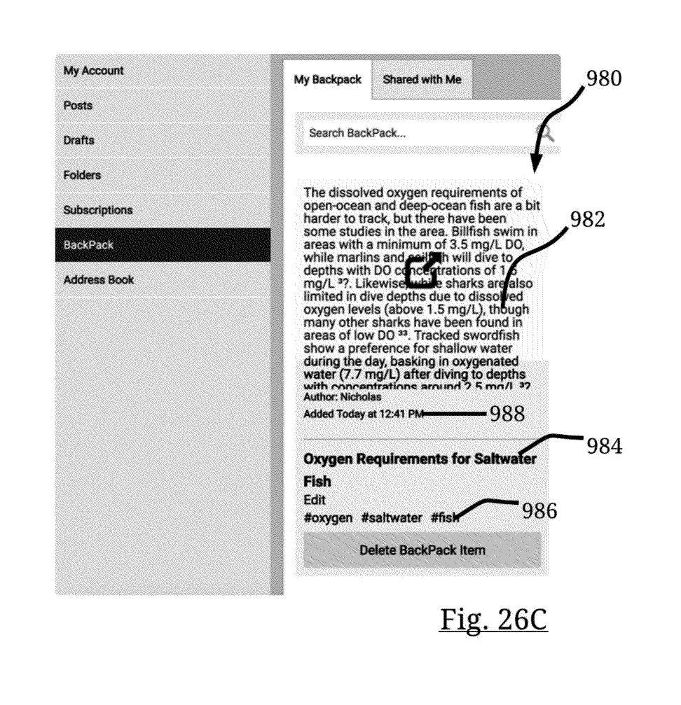

FIGS. 26A-26C are screenshots of a user interface on a personal device used in capturing content and forming a research block for a method of annotating webpages in accordance with another embodiment of the present invention. In this example, the content is captured by highlighting a portion of the website displayed in the web browser and actuating a Research button on the web browser to capture the highlighted portion as the content. The portion of the website can be a text portion or an image portion. In one embodiment, an overlay to the website can include Mark up This Page options; Send to Backpack options; Send to Draft options; Quick Share options; View Posts options, or the like, as described for FIG. 25B. In another embodiment, the web browser can include a Send to Draft button, Send to Backpack button, Quick Share button, Quick Save to Draft button, or the like.

The content can be content 912 including a text portion 914 and an image portion 916 displayed on a website 910 as described in conjunction with FIG. 25A. Referring to FIG. 26A, the text portion 914 has been highlighted by the user and right clicking on the highlighted text portion 914 opens options list 960 including a Post to CampCite option 962 overlaying the website 910.

Referring to FIG. 26B, the actuation of the CampCite option 962 captures the text in the highlighted text portion 914 and opens Save to Backpack popup 970 overlaying the website 910. The user can enter the research block title 972 and optional tags 974 to assist in identifying the content. The captured text 976 is displayed in the Save to Backpack popup 970. In one embodiment, the captured text 976 can be edited or highlighted as desired. The Save to Backpack popup 970 also includes a Save & Exit button 978 which can be actuated to save the captured text 976 to the Backpack data storage.

Referring to FIG. 26C, the actuation of the Save & Exit button 978 stores storing the research block 980 in Backpack data storage remote from the personal device. The research block 980 displayed in the web browser includes the content, i.e., the captured text 982, the research block title 984, and the optional tags 986. In one embodiment, the research block 980 can also be displayed with the saved time 988 at which the research block 980 was saved.

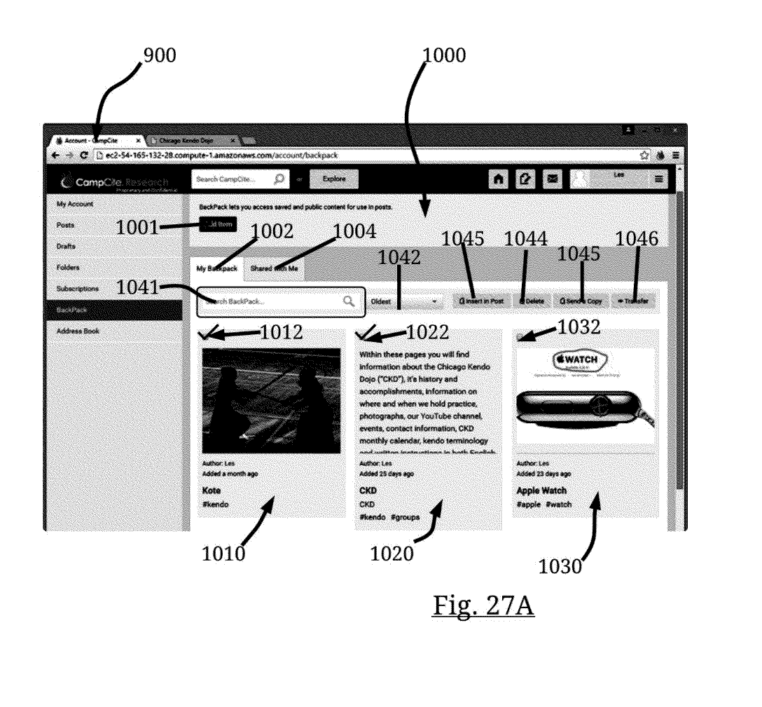

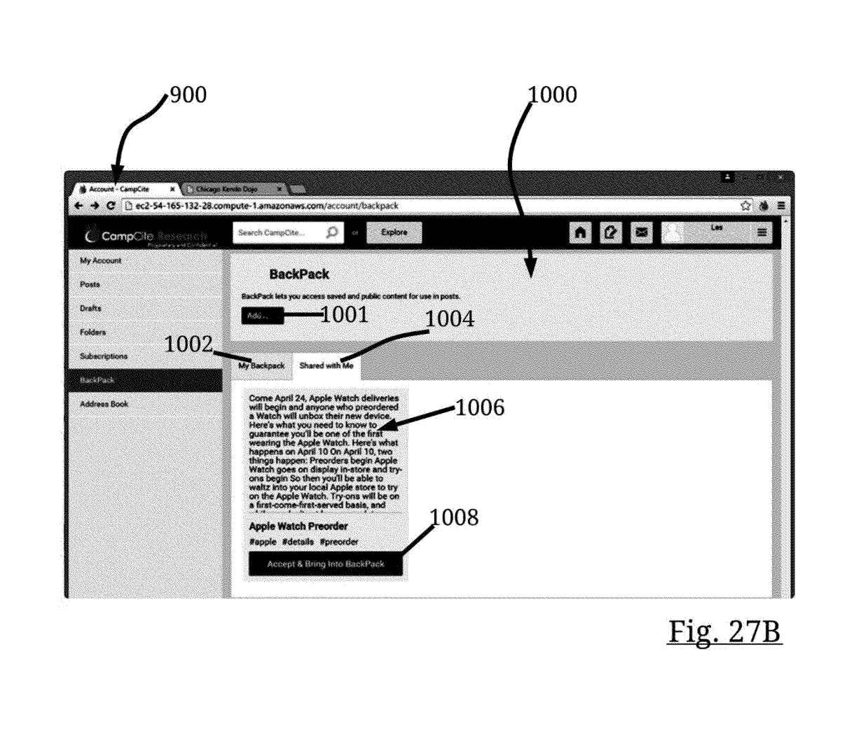

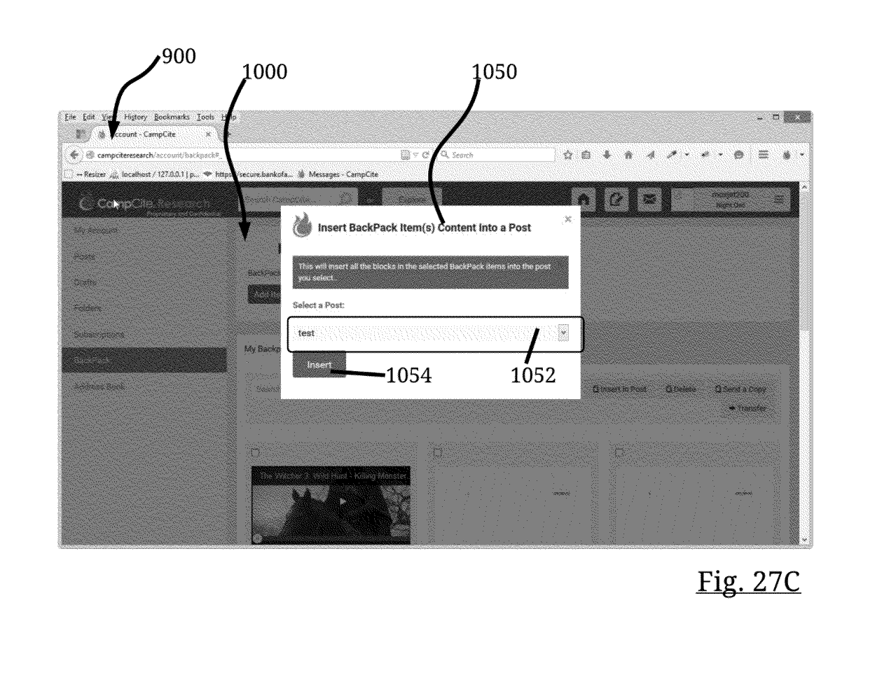

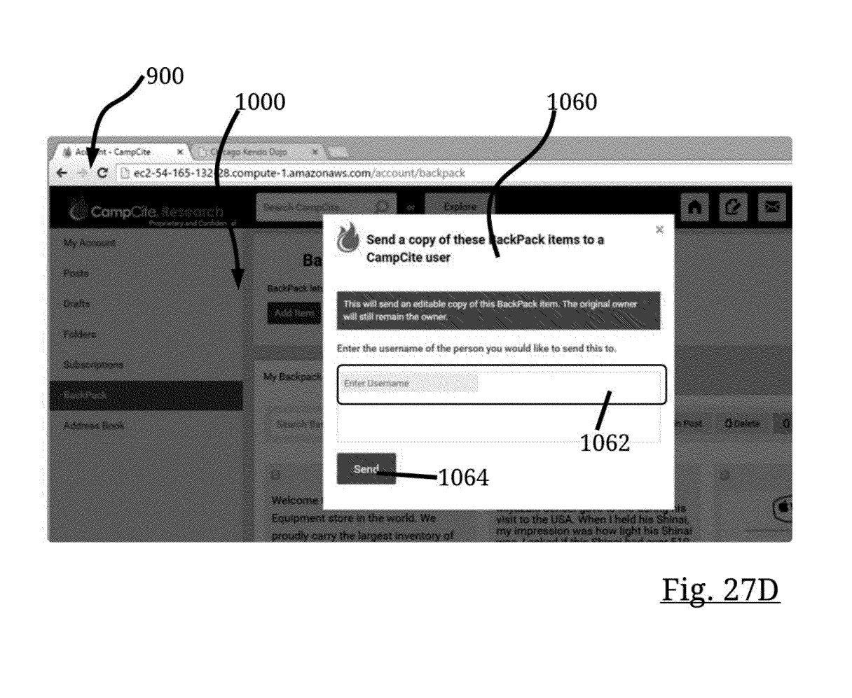

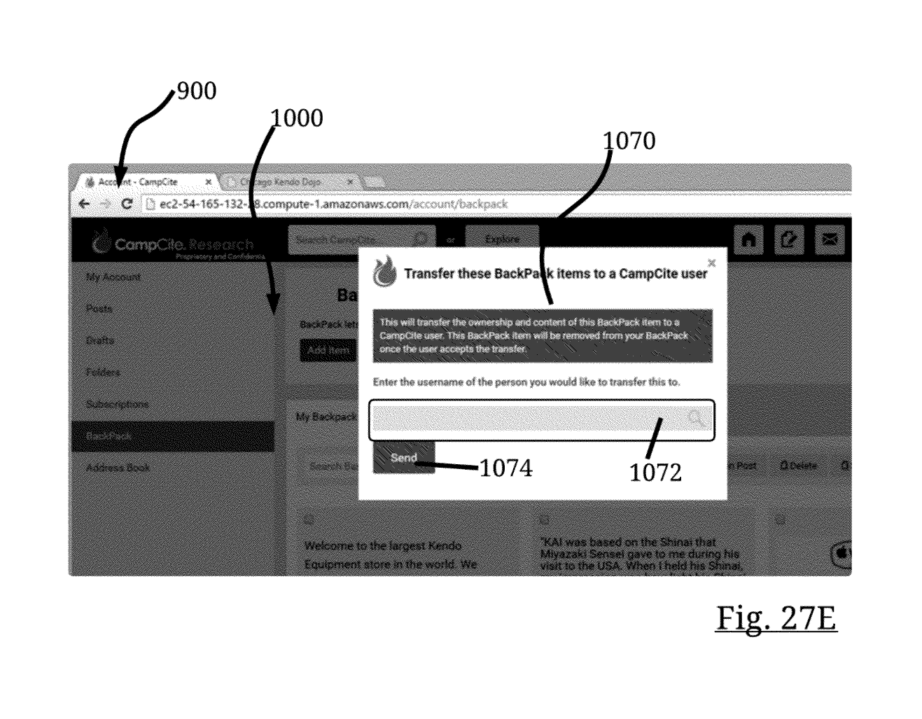

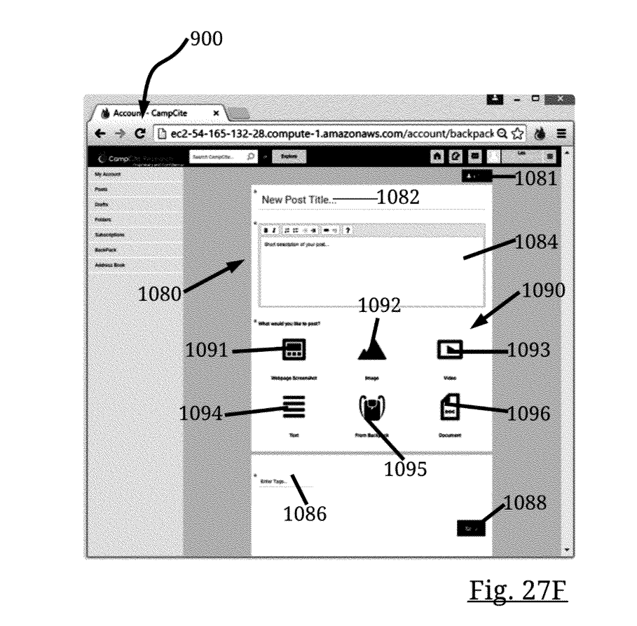

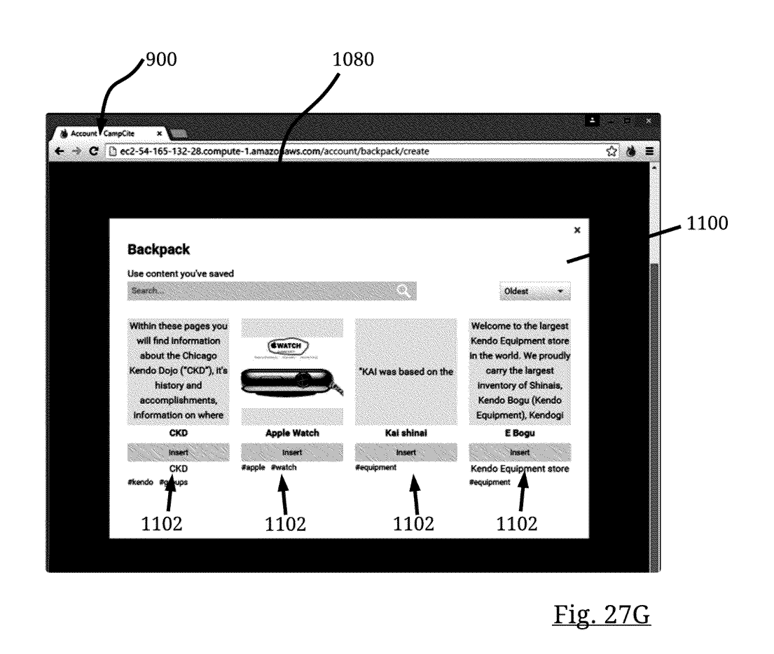

FIGS. 27A-27G are screenshots of a Backpack user interface for use in a method of annotating webpages in accordance with another embodiment of the present invention. A Backpack user interface displayed in a web browser can be used to send research blocks to other users.

Referring to FIG. 27A, a Backpack user interface 1000 is displayed in a web browser 900 on a personal device (not shown). In this example, the Backpack user interface 1000 has the My Backpack tab 1002 selected and includes a number of research blocks 1010, 1020, 1030, with each of the research blocks 1010, 1020, 1030 including a checkbox 1012, 1022, 1032, respectively. The research blocks 1010, 1020 are selected as indicated by the checkmark in their respective checkboxes 1012, 1022. The research block 1030 is unselected. Each of the research blocks 1010, 1020, 1030 also includes content, save time, research block title, and optional tags displayed for the research block.

Referring to FIG. 27B, a Backpack user interface 1000 is displayed in a web browser 900 on a personal device (not shown) with the Shared with Me tab 1004 selected. The Shared with Me tab 1004 in this example includes a single research block 1006 provisionally delivered to the user, either as a copy or a transfer from another user. The research block 1006 includes an Accept & Bring into Backpack button 1008. The user can move the research block 1006 into their own Backpack data storage by actuating the Accept & Bring into Backpack button 1008 to move the research block 1006 from the Shared with Me tab 1004 to the My Backpack tab 1002.

Referring to FIG. 27A, the Backpack user interface 1000 also has a Backpack toolbar 1040 including a search box 1041 four searching the research blocks, a sort drop-down list 1042 for sorting the research blocks, an Insert in Post button 1043, a Delete button 1044, a Send a Copy button 1045, and a Transfer button 1046. When actuated, the Insert in Post button 1043, a Delete button 1044, a Send a Copy button 1045, and a Transfer button 1046 act on the research blocks selected with a check mark in their checkboxes 1012, 1022, 1032, i.e., the action can be performed on a number of research block with a single actuation of the desired button. The Delete button 1044 deletes selected research blocks when the Delete button 1044 is actuated.

Referring to FIG. 27C, actuation of the Insert in Post button 1043 opens a Post box 1050 in the web browser 900 overlaying the Backpack user interface 1000. The Post box 1050 includes a Post Location drop-down box 1052 and a Send button 1054. The user can select a Post location from the Post Location drop-down box 1052, then send the selected research block or blocks to the selected post location by actuating the Send button 1054. In one embodiment, the research block in the post location is editable and/or no change is made to the ownership of the research block.

Referring to FIG. 27D, actuation of the Send a Copy button 1045 opens a Copy box 1060 in the web browser 900 overlaying the Backpack user interface 1000. The Copy box 1060 includes a User box 1062 and a Send button 1064. The user can enter a username of a second user in the User box 1062, then send the selected research block or blocks to the second user by actuating the Send button 1064. In one embodiment, the research block received by the second user is editable and/or no change is made to the ownership of the research block. In one embodiment, the research block is provisionally delivered to the second user and the second user can accept the research block into the Backpack data storage of the second user or can decline to accept the research block. The original research block remains in the Backpack of the user sending out the copy of the research block.

Referring to FIG. 27E, actuation of the Transfer button 1046 opens a Transfer box 1070 in the web browser 900 overlaying the Backpack user interface 1000. The Transfer box 1070 includes a User box 1072 and a Send button 1074. The user can enter a username of a second user in the User box 1072, then transfer the selected research block or blocks to the entered second user by actuating the Send button 1074. In one embodiment, the ownership of the research block can be changed from the user transferring the research block to the second user. In one embodiment, the research block is provisionally delivered to the second user and the second user can accept the research block into the Backpack data storage of the second user or can decline to accept the research block. In one embodiment, the original research block can be removed from the Backpack data storage of the user transferring the research block.

Referring to FIG. 27A, the Backpack user interface 1000 also has an Add Item button 1001 for generating a document. Referring to FIG. 27F, actuation of the Add Item button 1001 opens a Draft Item box 1080 in the web browser 900. The Draft Item box 1080 includes an Editors button 1081, a document title 1082, a summary description 1084, a document content toolbox 1090, tags 1086, and a Save button 1088. The user can enter the document title 1082, summary description 1084, and tags 1086 as desired for a particular document.

The document content toolbox 1090 can be used to add content to the document. The document context toolbox 1090 includes a Webpage Screenshot button 1091, an Image button, 1092, a Video button 1093, a Text button 1094, a From Backpack button 1095, and a Document button 1096. Actuating the Webpage Screenshot button 1091 opens a window allowing the user to input a webpage URL for retrieval of the webpage as a screenshot. Actuating the Image button 1092 opens a window allowing the user to upload an image file from the computer of the user or to input an image URL for retrieval of the image. Actuating the Video button 1093 opens a window allowing the user to input a video URL for retrieval of the video. Actuating the Text button 1094 opens a window allowing the user to input text. Actuating the Document button 1096 opens a window allowing the user to upload a document file from the computer of the user.

Referring to FIG. 27G, actuation of the From Backpack button 1095 opens a Backpack box 1100 in the web browser 900 overlaying the Draft Item box 1080. The Backpack box 1100 includes any research blocks 1102, which can be added to the document by actuating an Insert button 1104.

Referring to FIG. 27A, the Backpack user interface 1000 also has the Editors button 1081, which can be actuated to open a window allowing the user to input editors authorized to edit the document once saved. In one embodiment, the editors receive a notification that the document has been saved and is available for editing. In one embodiment, the user is included by default as the initial editor. The Save button 1088 can be actuated to save the document once the user has entered the desired information and content with the document content toolbox 1090. In one embodiment, the document is saved to the Backpack data storage of the user.

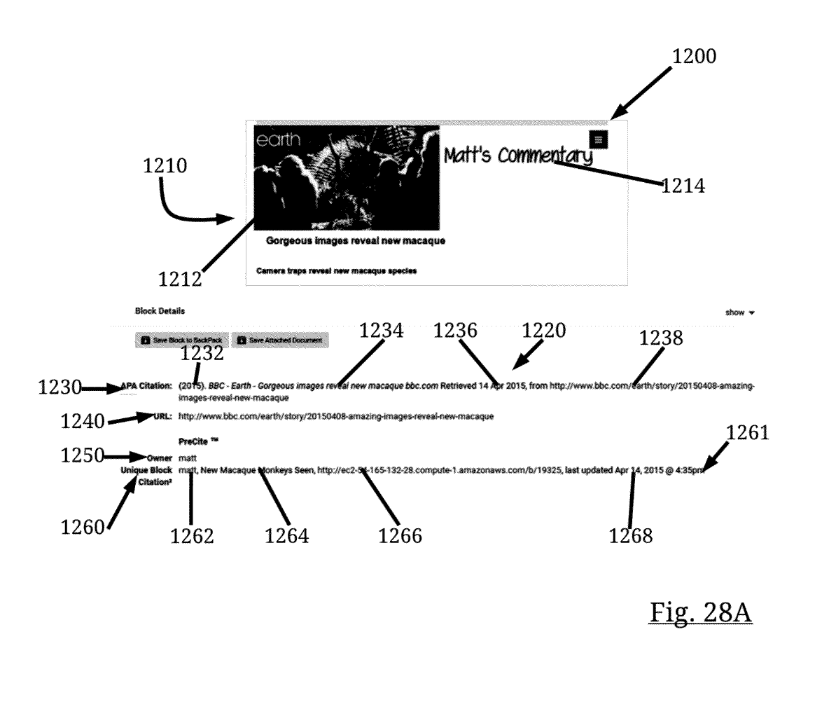

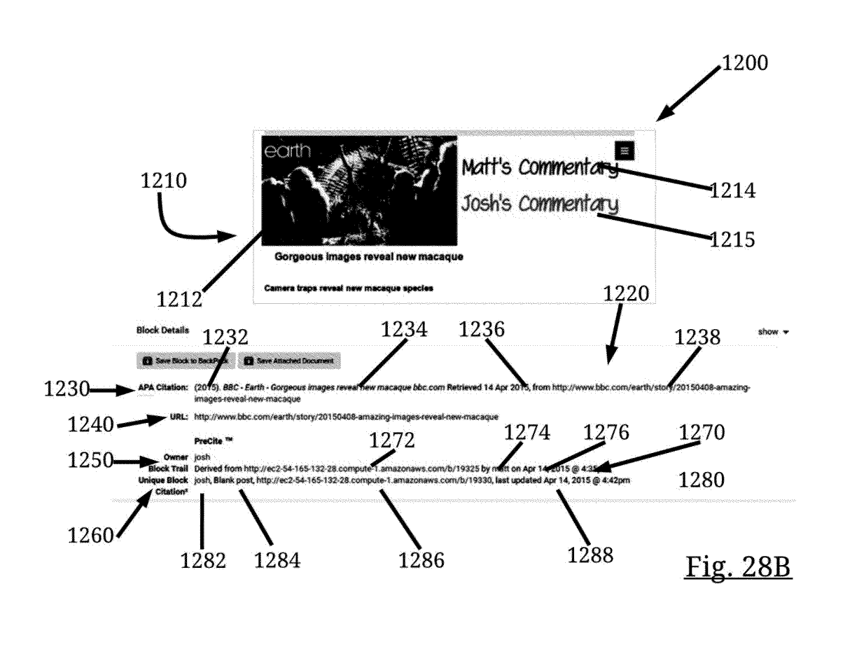

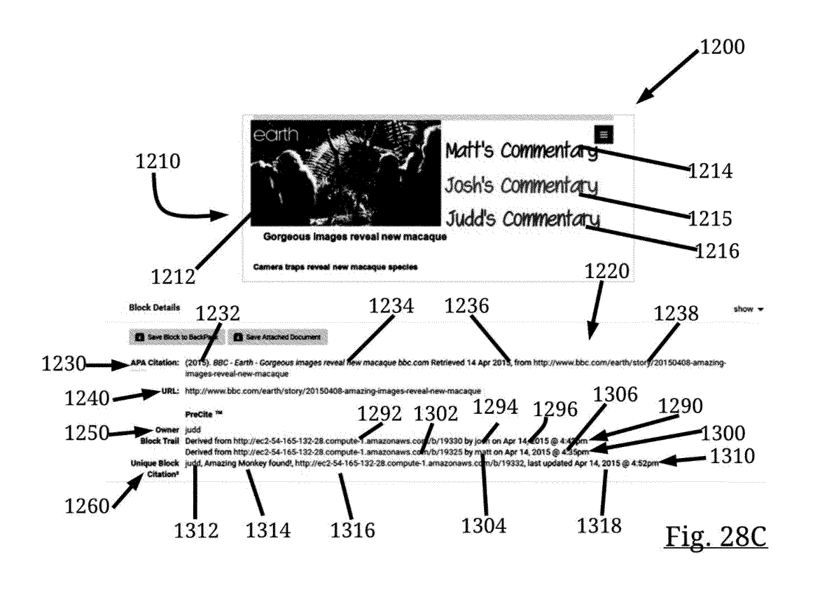

FIGS. 28A-28C are screenshots of a research block with linked information for use in a method of annotating webpages in accordance with another embodiment of the present invention. The linked information tracks the history of the research block. In this example, the research block is created by a first user, copied and modified by a second user, and copied and modified by a third user. As defined herein, a research block is copied when the research block is sent to or accessed by another user with the sender retaining a copy in the Backpack data storage of the user and retaining ownership.

Referring to FIG. 28A, the research block 1200 generated by the first user includes content 1210 and linked information 1220. The content 1210 includes captured content 1212 and edited content 1214 added to the captured content 1212 by the first user. The linked information 1220 in this example includes a citation 1230, a source URL 1240, an owner name 1250, and a block history 1260. Individual elements of the linked information can be hyperlinked when displayed, so that the user can open a window linked to the particular element.

In this example, the citation 1230 includes a generation date 1232, an article title 1234, a retrieval date 1236, and a source URL 1238. The citation 1230 is in APA format, but can be automatically formatted in accordance with the desired citation format, such as Simple Citation, APA, MLA, Chicago, Harvard, Vancouver, or the like, selected in the account settings for the user ID on the research service. The source URL 1240 is the URL for the source material in the captured content 1212.

In this example, the owner name 1250 and the block history 1260 are designated as part of the PreCite™ tracking service. The owner name 1250 identifies the owner of the research block, i.e., the initial author of the research block or another user to whom the ownership has been transferred by purchase or donation. Here, the owner is the first user who generated the research block 1200. The block history 1260 includes a current history entry 1261, which includes the author 1262, the research block title 1264, the research service URL 1266, and the modification date 1268. In this example, there is only the current history entry 1261 for the block history 1260 because the author 1262 is the original creator of the research block.

Referring to FIG. 28B, the research block 1200 has been modified from the prior research block of FIG. 28A by a second user with the addition of second user edited content 1215 to the content 1210. The second user has downloaded the prior research block from a public posting, or has received and accepted a copy from the prior owner. Referring to FIG. 28B, the block history 1260 has been automatically modified to include a new current history entry 1280 for the current research block 1200 and a prior history entry 1270 based on the history entry for the prior research block. The prior history entry 1270 includes the research service URL 1272, the author 1274, and the modification date 1276. The current history entry 1280 includes the author 1282, the research block title 1284, the research service URL 1286, and the modification date 1288. The owner name 1250 has also been automatically modified to include the name of the new owner who created the current research block 1200.

Referring to FIG. 28C, the research block 1200 has been modified from the prior research block of FIG. 28B by a third user with the addition of third user edited content 1216 to the content 1210. The third user has downloaded the prior research block from a public posting, or has received and accepted a copy from the prior owner. Referring to FIG. 28C, the block history 1260 has been automatically modified to include a new current history entry 1310 for the current research block 1200, a prior history entry 1300 based on the history entry for the second user prior research block, and another prior history entry 1290 based on the history entry for the original user prior research block. The second user prior history entry 1300 includes the research service URL 1302, the author 1304, and the modification date 1306. The original user prior history entry 1290 includes the research service URL 1292, the author 1294, and the modification date 1296. The current history entry 1310 includes the author 1312, the research block title 1314, the research service URL 1316, and the modification date 1318. The owner name 1250 has also been automatically modified to include the name of the new owner who created the current research block 1200.

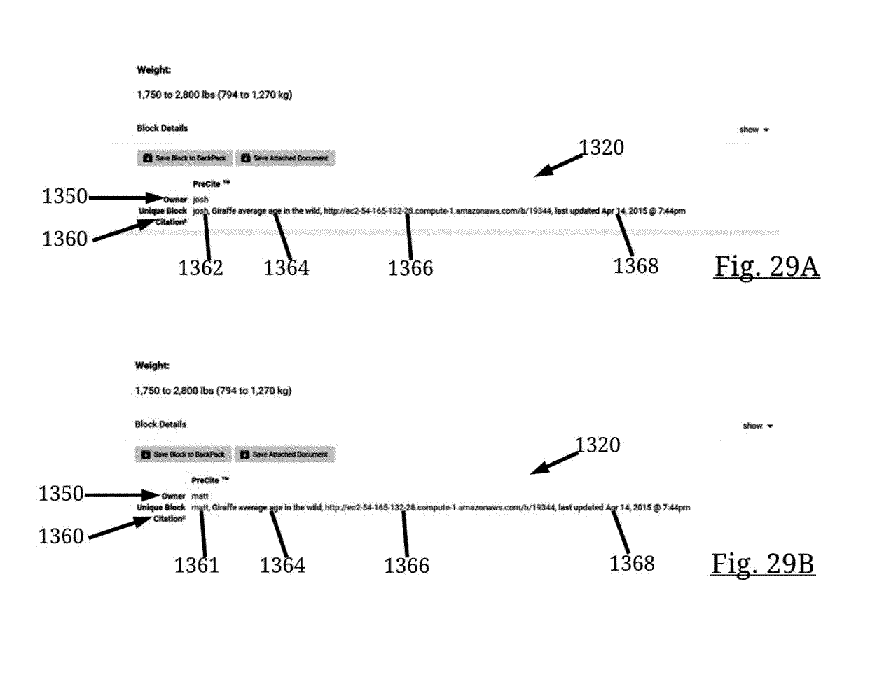

FIGS. 29A & 29B are screenshots of a research block with linked information for use in a method of annotating webpages in accordance with another embodiment of the present invention. The linked information tracks the history of the research block. In this example, the research block is created by a first user and transferred to a second user. As defined herein, a research block is transferred when the research block is sent to or accessed by another user with the sender deleting the original research block in the Backpack data storage of the user and transferring ownership to the other user. In one embodiment, the owner name in linked data of the research block is changed to that of the other user.

Referring to FIG. 29A, the linked information 1320 in this example includes an owner name 1350 and a block history 1360. The linked information 1320 is part of a research block generated by the first user. In this example, the owner name 1350 identifies the initial author of the research block. The block history 1360 includes the author 1362, the research block title 1364, the research service URL 1366, and the modification date 1368.

Referring to FIG. 29A, the research block has been transferred from the first user to the second user. The owner name 1350 has been automatically modified to change the name from the first user to the second user. The author 1361 in the block history 1360 has also been automatically modified to change the name from the first user to the second user. The other elements of the block history 1360, i.e., the research block title 1364, the research service URL 1366, and the modification date 1368, remain unchanged.

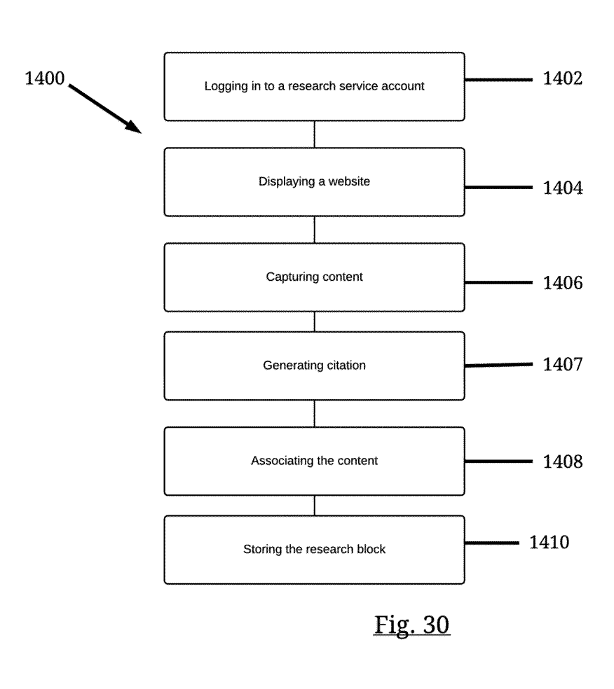

FIG. 30 is a flowchart for a method of annotating webpages in accordance with one embodiment of the present invention. The method 1400 can operate on a system as illustrated in FIG. 1. In various embodiments, the method 1400 can be used to form research blocks, exchange research blocks with others while tracking research block history, buy and sell research blocks, and analyze the market in research blocks.

Referring to FIG. 30, the method 1400 can form a research block including content and linked information. In one embodiment, the method 1400 for annotating webpages by a user of a research service includes logging in to a research service account 1402 under an owner name associated with the user, the research service account including data storage for the user; displaying a website 1404 having a URL in a web browser on a personal device; capturing content from the website 1406; generating a citation for the captured content 1407; associating the content 1408 with linked information to form a research block, the linked information including the citation, the owner name, the URL, and a creation date; and storing the research block 1410 in the data storage remote from the personal device. In one embodiment, the linked information further includes information such as a block title, descriptor, indexing tags, tracking information, or the like. In one embodiment, the data storage is Backpack data storage, draft data storage, and post data storage, or the like.

The capturing content from the website 1406 can capture all or part of the website. In one embodiment, the capturing content from the website 1406 can include actuating a Research button on the web browser to capture a screen shot as the content. In one embodiment, the method 1400 can further include actuating a Share button on the web browser to share the screenshot over an application selected from email, social media, or the like. In one embodiment, the method 1400 can further include actuating a Backpack Save button on the web browser to save the screenshot to Backpack data storage. In one embodiment, the method 1400 can further include actuating a Quick Share button on the web browser to simultaneously share the screenshot over an application selected from email, social media, or the like, and store the screenshot in Backpack data storage.

The method 1400 can then further include editing the captured screenshot with editing tools in the web browser on the personal device. In one embodiment, the method 1400 can further include actuating a Share button on the web browser to share the edited screenshot over an application selected from email, social media, or the like. In one embodiment, the method 1400 can further include actuating a Backpack Save button on the web browser to save the edited screenshot to Backpack data storage. In one embodiment, the method 1400 can further include actuating a Quick Share button on the web browser to simultaneously share the edited screenshot over an application selected from email, social media, or the like, and store the edited screenshot in Backpack data storage.

In another embodiment capturing part of the website, the capturing content from the website 1406 can include highlighting a portion of the website displayed in the web browser and actuating a Research button on the web browser to capture the highlighted portion as the content. The highlighted portion can be a text portion or an image portion. In one embodiment, the highlighted portion can be edited with editing tools in the web browser on the personal device.

The method 1400 can further include storing and/or sharing of part of the website. In one embodiment, the capturing content from the website 1406 includes highlighting a portion of the website displayed in the web browser and actuating a Send to Draft button on the web browser to store the portion in the data storage including draft data storage, post data storage, or the like. In one embodiment, the capturing content from the website 1406 includes highlighting a portion of the website displayed in the web browser and actuating a Send to Backpack button on the web browser to store the portion in Backpack data storage. In one embodiment, the capturing content from the website 1406 includes highlighting a portion of the website displayed in the web browser and actuating a Quick Share button on the web browser to simultaneously share the portion over an application including email, social media, or the like, and store the portion to Backpack data storage. In one embodiment, the capturing content from the website 1406 includes highlighting a portion of the website displayed in the web browser and actuating a Quick Save to Draft button on the web browser to simultaneously store the portion in the data storage including draft data storage, post data storage, or the like, and store the portion in Backpack data storage.

The method 1400 can further include sending the research block to another user, with or without maintaining the research block or ownership with the first user. In one embodiment with an Insert in Post button, the method 1400 can further include displaying the research block in a Backpack user interface in the web browser; selecting the research block; and actuating an Insert in Post button displayed in the Backpack user interface to make a copy of the research block available to a second user. In another embodiment, the actuating can further include displaying a menu of locations in the data storage accessible to the second user, the method further comprising selecting one of the locations from the menu to save the copy of the research block in the one of the locations. In another embodiment, the actuating can further include designating the second user as an editor of the research block and storing the copy of the research block in a location in the data storage accessible to the second user.

In another embodiment with a Send a Copy button, the method 1400 can further include displaying the research block in a Backpack user interface in the web browser; selecting the research block; and actuating a Send a Copy button displayed in the Backpack user interface to send a copy of the research block to a second user. In sending the copy, the research block can be provisionally delivered to the second user, who can accept or decline the research block. The research block can be maintained in the data storage and/or the ownership of the research block can be maintained with the first user.

In yet another embodiment with a Transfer button, the method 1400 can further include displaying the research block in a Backpack user interface in the web browser; selecting the research block; and actuating a Transfer button displayed in the Backpack user interface to transfer a copy of the research block to a second user. In sending the copy, the research block can be provisionally delivered to the second user, who can accept or decline the research block. The research block can be removed from the data storage and/or the ownership of the research block can be changed from the first user to the second user. The removing can include removing the research block from the data storage on the accepting the research block by the second user.

The research block can be one of a number of research blocks. In one embodiment, the research block in the data storage is one of a number of research blocks stored in the data storage, the research blocks being displayed in a Backpack user interface in the web browser. The method 1400 can further include selecting research blocks from the number of research blocks; and actuating a button displayed in the Backpack user interface to perform an action on the selected research blocks, the action being Insert in Post, Delete, Send a Copy, and Transfer. In one embodiment, the research block in the data storage is one of a number of research blocks stored in the data storage, the plurality of research blocks being displayed in a user interface in the web browser, the method 1400 can further include selecting research blocks from the displayed number of research blocks; and actuating a Send to Backpack button displayed in the user interface to save the selected research blocks to Backpack data storage of the user.

The method 1400 can further include selling the research blocks on a research block exchange. In one embodiment, the method 1400 can further include posting the research block on a research block exchange at an asking price; receiving an offer to purchase from a second user; accepting the offer to purchase; and delivering the research block to the second user by sending a copy of the research block to the second user or transferring the research block to the second user. In one embodiment in which the received offer includes an offer price and the accepted offer includes a purchase price, the method 1400 can further include aggregating data including the asking price, the offer price, and the purchase price into a market database, the market database including a number of asking prices, a number of offer prices, and a number of purchase prices for transactions by a number of users posted on the research block exchange; and analyzing the market database to generate market analytics including current market prices, historic market performance, projected market performance, or the like.

In another embodiment, the method 1400 can further include posting the research block on a research block exchange; negotiating a purchase price with a second user; receiving the purchase price from the second user; and delivering the research block to the second user by sending a copy of the research block to the second user or transferring the research block to the second user. In one embodiment, various entities facilitating the sale of the research blocks, such as the research service operating the research block exchange, the payment processing service, or the like receive a fee or a portion of the purchase price before payment is made to the first user. In one embodiment, the method 1400 can further include aggregating data including the purchase price into a market database, the market database including a number of purchase prices for transactions by a number of users posted on the research block exchange; and analyzing the market database to generate market analytics including current market prices, historic market performance, projected market performance, or the like.

The method 1400 can further include custom production and sale of research blocks. In one embodiment, the method 1400 can further include posting the first user as an researcher-for-hire on an research exchange; receiving a work request from a second user, the work request including a research scope; negotiating a price for work to meet the research scope with the second user; performing the displaying, the capturing, the associating, and the storing to generate the research block in accordance with the research scope; and delivering the research block to the second user by sending a copy of the research block to the second user or transferring the research block to the second user. In one embodiment, various entities facilitating the sale of the research blocks, such as the research service operating the research block exchange, the payment processing service, or the like receive a fee or a portion of the price before payment is made to the first user. The posting the user can further include posting on the research exchange for the first user researcher qualifications, researcher experience, or researcher expertise, such as education, experience, professional credentials, or the like. In one embodiment, the research service can review the researcher qualifications for accuracy or to determine in which research service specified classification level of expertise the first user should be placed. Aas used herein, a researcher can be an original author, a person compiling, annotating or adapting the work of others to produce research blocks.

The method 1400 can further include market analysis of transactions in research blocks. In one embodiment, the method 1400 can further include aggregating data including the research scope and the negotiated price for the delivered research block into a market database, the market database including a number of received research scopes and a number of negotiated prices for transactions by a number of users posted as researchers-for-hire on the research exchange; and analyzing the market database to generate market analytics such as current market prices, historic market performance, projected market performance, or the like. The market analytics can also take other factors into account, such as the expertise level of the researchers-for-hire, difficulty of research topic, number of research blocks, or the like. The market analytics can be provided to prospective buyers and sellers of research blocks to establish pricing and facilitate transactions. In one embodiment in which a researcher has produced or is considering producing a research block, the research service can use the market analytics to calculate a suggested selling price for a research block, based on factors such as researcher expertise, topic difficulty, and the like. In another embodiment in which a prospective purchaser is considering commissioning a research block, the research service can use the market analytics to calculate a suggested purchase price for a research block, based on factors such as researcher expertise required, topic difficulty, and the like.

One method for annotating webpages by a user of a research service can include entering a URL for a website in a web browser on a personal device. The method can include logging in to a research service account under an owner name associated with the user, the research service account including data storage for the user; entering a URL for a website in a web browser on a personal device to capture content from the website; generating a citation for the captured content; associating the content with linked information to form a research block, the linked information including the citation, the owner name, the URL, and a creation date; and storing the research block in the data storage remote from the personal device. In one embodiment, the linked information further includes information such as a block title, descriptor, indexing tags, tracking information, or the like. In one embodiment, the data storage consists of Backpack data storage, draft data storage, post data storage, or the like.

The methods for annotating webpages described herein can operate on devices and systems as desired for a particular application. In one example, a device for annotating webpages with user input of a user includes a user interface for receiving the user input; a processor coupled to the user interface; and a memory coupled to the processor. The memory can include programming code responsive to the user input to the user interface to: log in to a research service account under an owner name associated with the user, the research service account including data storage for the user; display a website having a URL in a web browser on a personal device; capture content from the website; generate a citation for the captured content; associate the content with linked information to form a research block, the linked information including the citation, the owner name, the URL, and a creation date; and store the research block in the data storage remote from the personal device. In one embodiment, the linked information further includes information such as a block title, descriptor, indexing tags, tracking information, or the like. In one embodiment, the data storage consists of Backpack data storage, draft data storage, post data storage, or the like.

In one example, a system for annotating webpages includes data storage; and a personal device having a user interface to receive user input of a user and being operably connected to communicate with the data storage, the data storage being remote from the personal device. the personal device can be responsive to the user input to: log in to a research service account under an owner name associated with the user, the research service account including the data storage for the user; display a website having a URL in a web browser on the personal device; capture content from the website; generate a citation for the captured content; associate the content with linked information to form a research block, the linked information including the citation, the owner name, the URL, and a creation date; and store the research block in the data storage. In one embodiment, the linked information further includes information such as a block title, descriptor, indexing tags, tracking information, or the like. In one embodiment, the data storage consists of Backpack data storage, draft data storage, post data storage, or the like.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A method for annotating webpages by a user of a research service, the method comprising:
logging in to a research service account under an owner name associated with the user, the research service account including data storage for the user;
displaying a website having a URL in a web browser on a personal device;
capturing content from the website;
generating a citation for the captured content;
associating the content with linked information to form a research block, the linked information including the citation, the owner name, the URL, and a creation date; and
storing the research block in the data storage remote from the personal device.

2. The method of claim 1 wherein the linked information further includes information selected from the group consisting of a block title, descriptor, indexing tags, and tracking information.

3. The method of claim 1 wherein the data storage is selected from the group consisting of Backpack data storage, draft data storage, and post data storage.

4. The method of claim 1 wherein the capturing content comprises actuating a Research button on the web browser to capture a screenshot as the content.

5. The method of claim 4 further comprising actuating a Share button on the web browser to share the screenshot over an application selected from the group consisting of email and social media.

6. The method of claim 4 further comprising actuating a Backpack Save button on the web browser to save the screenshot to Backpack data storage.

7. The method of claim 4 further comprising actuating a Quick Share button on the web browser to simultaneously share the screenshot over an application selected from the group consisting of email and social media and store the screenshot in Backpack data storage.

8. The method of claim 4 further comprising editing the screenshot with editing tools in the web browser on the personal device.

9. The method of claim 8 further comprising actuating a Share button on the web browser to share the edited screenshot over an application selected from the group consisting of email and social media.

10. The method of claim 8 further comprising actuating a Backpack Save button on the web browser to save the edited screenshot to Backpack data storage.

11. The method of claim 8 further comprising actuating a Share/Save button on the web browser to simultaneously share the edited screenshot over an application selected from the group consisting of email and social media and save the edited screenshot to Backpack data storage.

12. The method of claim 1 wherein the capturing content comprises highlighting a portion of the website displayed in the web browser and actuating a Research button on the web browser to capture the highlighted portion as the content.

13. The method of claim 12 wherein the portion is selected from the group consisting of a text portion and an image portion.

14. The method of claim 12 further comprising editing the highlighted portion with editing tools in the web browser on the personal device.

15. The method of claim 1 wherein the capturing content comprises highlighting a portion of the website displayed in the web browser and actuating a Send to Draft button on the web browser to store the portion in the data storage selected from the group consisting of draft data storage and post data storage.

16. The method of claim 1 wherein the capturing content comprises highlighting a portion of the website displayed in the web browser and actuating a Send to Backpack button on the web browser to store the portion in Backpack data storage.

17. The method of claim 1 wherein the capturing content comprises highlighting a portion of the website displayed in the web browser and actuating a Quick Share button on the web browser to simultaneously share the portion over an application selected from the group consisting of email and social media, and store the portion to Backpack data storage

18. The method of claim 1 wherein the capturing content comprises highlighting a portion of the website displayed in the web browser and actuating a Quick Save to Draft button on the web browser to simultaneously store the portion in the data storage selected from the group consisting of draft data storage and post data storage, and store the portion in Backpack data storage.

19. The method of claim 1 wherein the user is a first user, the method further comprising:
displaying the research block in a Backpack user interface in the web browser;
selecting the research block; and
actuating an Insert in Post button displayed in the Backpack user interface to make a copy of the research block available to a second user.

20. The method of claim 19 wherein the actuating further comprises displaying a menu of locations in the data storage accessible to the second user, the method further comprising selecting one of the locations from the menu to save the copy of the research block in the one of the locations.

21. The method of claim 19 wherein the actuating further comprises designating the second user as an editor of the research block and storing the copy of the research block in a location in the data storage accessible to the second user.

22. The method of claim 1 wherein the user is a first user, the method further comprising:
displaying the research block in a Backpack user interface in the web browser;
selecting the research block; and
actuating a Send a Copy button displayed in the Backpack user interface to send a copy of the research block to a second user.

23. The method of claim 22 further comprising:
provisionally delivering the research block to the second user; and
the second user accepting the research block.

24. The method of claim 23 further comprising maintaining the research block in the data storage.

25. The method of claim 23 further comprising maintaining ownership of the research block with the first user.

26. The method of claim 1 wherein the user is a first user, the method further comprising:
displaying the research block in a Backpack user interface in the web browser;
selecting the research block; and
actuating a Transfer button displayed in the Backpack user interface to transfer a copy of the research block to a second user.

27. The method of claim 26 further comprising:
provisionally delivering the research block to the second user; and
the second user accepting the research block.

28. The method of claim 27 further comprising removing the research block from the data storage.

29. The method of claim 28 wherein the removing comprises removing the research block from the data storage on the accepting the research block by the second user.

30. The method of claim 27 further comprising changing ownership of the research block from the first user to the second user.

31. The method of claim 1 wherein the research block in the data storage is one of a plurality of research blocks stored in the data storage, the plurality of research blocks being displayed in a Backpack user interface in the web browser, the method further comprising:
selecting research blocks from the displayed plurality of research blocks; and
actuating a button displayed in the Backpack user interface to perform an action on the selected research blocks, the action being selected from the group consisting of Insert in Post, Delete, Send a Copy, and Transfer.

32. The method of claim 1 wherein the research block in the data storage is one of a plurality of research blocks stored in the data storage, the plurality of research blocks being displayed in a user interface in the web browser, the method further comprising:
selecting research blocks from the displayed plurality of research blocks; and
actuating a Send to Backpack button displayed in the user interface to save the selected research blocks to Backpack data storage of the user.

33. The method of claim 1 further comprising:
posting the research block on a research block exchange at an asking price;
receiving an offer to purchase from a second user;
accepting the offer to purchase; and
delivering the research block to the second user by an action selected from the group consisting of sending a copy of the research block to the second user and transferring the research block to the second user.

34. The method of claim 33 wherein the received offer includes an offer price and the accepted offer includes a purchase price, the method further comprising:
aggregating data including the asking price, the offer price, and the purchase price into a market database, the market database including a plurality of asking prices, a plurality of offer prices, and a plurality of purchase prices for transactions by a plurality of users posted on the research block exchange; and
analyzing the market database to generate market analytics selected from the group consisting of current market prices, historic market performance, and projected market performance.

35. The method of claim 1 wherein the user is a first user, the method further comprising:
posting the research block on a research block exchange;
negotiating a purchase price with a second user;
receiving the purchase price from the second user; and
delivering the research block to the second user by an action selected from the group consisting of sending a copy of the research block to the second user and transferring the research block to the second user.

36. The method of claim 35 further comprising:
aggregating data including the purchase price into a market database, the market database including a plurality of purchase prices for transactions by a plurality of users posted on the research block exchange; and
analyzing the market database to generate market analytics selected from the group consisting of current market prices, historic market performance, and projected market performance.

37. The method of claim 1 wherein the user is a first user, the method further comprising:
posting the first user as an researcher-for-hire on a research exchange;
receiving a work request from a second user, the work request including a research scope;
negotiating a price for work to meet the research scope with the second user;
performing the displaying, the capturing, the associating, and the storing to generate the research block in accordance with the research scope; and
delivering the research block to the second user by an action selected from the group consisting of sending a copy of the research block to the second user and transferring the research block to the second user.

38. The method of claim 37 wherein the posting the first user further comprises posting on the research exchange for the first user researcher information selected from the group consisting of researcher qualifications, researcher experience, and researcher expertise.

39. The method of claim 37 further comprising:
aggregating data including the research scope and the negotiated price for the delivered research block into a market database, the market database including a plurality of received research scopes and a plurality of negotiated prices for transactions by a plurality of users posted as researchers-for-hire on the research exchange; and
analyzing the market database to generate market analytics selected from the group consisting of current market prices, historic market performance, and projected market performance.

40. A method for annotating webpages by a user of a research service, the method comprising:
logging in to a research service account under an owner name associated with the user, the research service account including data storage for the user;
entering a URL for a website in a web browser on a personal device to capture content from the website;
generating a citation for the captured content;
associating the content with linked information to form a research block, the linked information including the citation, the owner name, the URL, and a creation date; and
storing the research block in the data storage remote from the personal device.

41. The method of claim 40 wherein the linked information further includes information selected from the group consisting of a block title, descriptor, indexing tags, and tracking information.

42. The method of claim 40 wherein the data storage is selected from the group consisting of Backpack data storage, draft data storage, and post data storage.

43. A device for annotating webpages with user input of a user, the device comprising:
a user interface for receiving the user input;
a processor coupled to the user interface; and
a memory coupled to the processor, the memory containing programming code responsive to the user input to the user interface to:
log in to a research service account under an owner name associated with the user, the research service account including data storage for the user;
display a website having a URL in a web browser on a personal device;
capture content from the website;
generate a citation for the captured content;
associate the content with linked information to form a research block, the linked information including the citation, the owner name, the URL, and a creation date; and
store the research block in the data storage remote from the personal device.

44. The device of claim 43 wherein the linked information further includes information selected from the group consisting of a block title, descriptor, indexing tags, and tracking information.

45. The device of claim 43 wherein the data storage is selected from the group consisting of Backpack data storage, draft data storage, and post data storage.

46. A system for annotating webpages, the system comprising:
data storage; and
a personal device having a user interface to receive user input of a user and being operably connected to communicate with the data storage, the data storage being remote from the personal device;
wherein the personal device is responsive to the user input to:
log in to a research service account under an owner name associated with the user, the research service account including the data storage for the user;
display a website having a URL in a web browser on the personal device;
capture content from the website;
generate a citation for the captured content;
associate the content with linked information to form a research block, the linked information including the citation, the owner name, the URL, and a creation date; and
store the research block in the data storage.

47. The system of claim 46 wherein the linked information further includes information selected from the group consisting of a block title, descriptor, indexing tags, and tracking information.

48. The system of claim 46 wherein the data storage is selected from the group consisting of Backpack data storage, draft data storage, and post data storage.
